(19) United States
(12) Patent Application Publication
(10) Pub. No.: US 2015/0324789 A1
(43) Pub. Date: Nov. 12, 2015

(54) Cryptocurrency Virtual Wallet System and Method

(71) Applicant: Case Wallet, Inc., Rochester, NY (US)

(72) Inventors: John Dvorak, West Liberty, IA (US); Melanie Shapiro, New York, NY (US); Josh Billings, Rockland, MA (US); Chester Taylor, Hillsboro, OR (US); Eric Falkenberg, Logan TWP, NJ (US); Stephen Schultz, West Henrietta, NY (US)

(21) Appl. No.: 14/705,911

(22) Filed: May 6, 2015

Related U.S. Application Data
(60) Provisional application No. 61/989,116, filed on May 6, 2014.
(60) Provisional application No. 62/042,069, filed on Aug. 26, 2014.

(51) Int. Cl. G06Q 20/36; G06Q 20/38

(52) U.S. Cl. CPC G06Q 20/3678; G06Q 20/3674; G06Q 20/3823; G06Q 2220/00

(57) ABSTRACT

The present disclosure describes a method in which an encrypted request to transfer a requested amount of cryptocurrency from a user address to a destination address is received. The request includes a destination address, a requested amount, a user device encryption key, and biometric data. A partially signed transaction to transfer a requested amount of cryptocurrency from the user address to the destination address is also received. The partially signed transaction is cryptographically signed and a multi-signed transaction is broadcast to a cryptocurrency network to transfer the requested amount of cryptocurrency from the user address to the destination address.

### CROSS-REFERENCE TO RELATED APPLICATIONS

The present application claims priority to U.S. Provisional Patent Application No. 61,989,116 filed May 6, 2014 and U.S. Provisional Patent Application No. 62/042,069 filed Aug. 8, 2014. All forementioned applications are hereby incorporated by reference in their entirety.

### FIELD OF THE DISCLOSURE

The present disclosure relates generally to virtual wallets used to store and execute transactions using cryptocurrency. More specifically, the present disclosure is a cryptocurrency virtual wallet system and method which overcomes problems existing in the prior art and simplifies existing methodologies and provides enhanced security. In one version, the cryptocurrency virtual wallet system and method has increased security by utilizing three encryption keys to secure the bitcoins in the wallet. The encryption keys are stored in separate locations and secured by distinct authentication factors to create no single point of failure.

### BACKGROUND

Many modern economies are based largely upon transactions involving currency. In recent years, electronic currency transactions have become increasingly prevalent. Most electronic transactions function using government supported currencies; however, several virtual currencies have surfaced in recent years which offer an alternative to government regulated currencies. Such virtual currencies are not issued by centralized authorities like the U.S. department of the treasury. Instead, virtual currencies are regulated by cryptographic methods which manage and control the currency; this method of regulation has given rise to the term cryptocurrency, which is commonly used to describe such cryptographically regulated currencies. The value of most cryptocurrencies is based entirely on their open market valuation. As cryptocurrencies gain more widespread acceptance as a medium of exchange for goods, their relative value also rises.

In recent years, many companies and organizations have been investing large amounts of time and money into developing new methods which facilitate the storage and exchange of cryptocurrencies. One particular cryptocurrency which was the first of its kind is Bitcoin. Upon its initial introduction, bitcoins had almost no value, as there was essentially no infrastructure for their exchange, and no merchants who were willing to accept the currency. Initially, bitcoins had to be exchanged exclusively peer to peer with negotiations between parties being the only determining factor in the amount of bitcoins to be exchanged. In recent years, bitcoins and other cryptocurrencies have become much more widely accepted among various different Internet based organizations and merchants.

Bitcoins are typically stored in a wallet which is represented by a pair of keys. The public key is the wallet's public address and the private encryption key is the wallet password, granting its bearer the ability to spend the bitcoins contained in the wallet. There are many different ways in which these cryptocurrency wallets can be stored and accessed, such as on a hard drive, smartphone, or on an internet accessible server. Some people may choose to store their bitcoins themselves on computers, physical drives, smartphones, or other devices which they actually own. Unfortunately this does leave a person open to loss. If their hard drive or device is hacked, physically stolen, or destroyed, they can lose all of their bitcoins very easily. Some people password-protect their wallets for added security but viruses, keystroke loggers, and other malware leave such wallets unprotected as well.

In order to facilitate the exchange of bitcoins and other cryptocurrencies between peers and merchants, many virtual wallets have been introduced. Such virtual wallets typically store a user's bitcoins on a secure server where they can be accessed. Virtual wallets attempt to do two primary things; one, make it very easy to pay for transactions via Bitcoin. And two, reduce the amount of risk in storing the bitcoins. Most virtual wallets store all or part of the user's bitcoin balance on a server and the user's account is simply password protected or protected with two factor authentication.

This means that if the server is ever compromised, it is very easy for malevolent parties to steal any bitcoins that were stored on the server. It also means that if the user is accessing the virtual wallet from a device that has been compromised by virus or malware, transactions can be redirected by a malevolent party to an unintended recipient. These are very grave security flaws, which can be found in many of the commercially available virtual wallets.

It is clear that there is a need for a more secure virtual wallet that is easy to use. Additionally, it would be beneficial to provide a physical implement which could be utilized to pay for items and services using cryptocurrency at physical merchants instead of only electronic based merchants. It is therefore an object of the present invention to introduce a cryptocurrency virtual wallet system and method which solves the issues mentioned above. The present invention incorporates a physical card which is able to facilitate transfer of cryptocurrency when a user is shopping at a physical store. The physical card does not run general purpose software and does not allow software to be downloaded so it is not susceptible to viruses and malware in the way that computers and smartphones are susceptible to such threats. The present invention is also a significant improvement over past and other currently available virtual wallets in the way it stores the bitcoins. Instead of storing the encryption key on a server like many virtual bitcoin wallets do, the present invention utilizes three keys that are stored in three different locations; one key is stored on the physical card, one is stored on the server, and the third is stored in a secure data vault. Each key storage location is secured using a distinct authentication factor and two out of three keys are needed for a transaction to take place. Thus, even if the server is compromised, or the physical card is lost, only one of the three encryption keys is compromised. Furthermore, the virtual wallet integrates biometric authentication technology such that even if another person were to steal the card, they cannot utilize it to access the card owner's bitcoins. On the other hand, the rightful owner of the card is able to unlock both of the encryption keys needed to execute a transaction with one simple interaction.

### BRIEF SUMMARY

The present disclosure addresses limitations known in the art relating to cryptocurrency transactions, including but not limited to Bitcoin currency. In particular, the present disclosure describes a system, method, and apparatus usable to receive and transmit funds, store funds in a secure manner, verify user credentials, etc. In certain embodiments, the presently disclosed inventive concepts include a cryptocurrency virtual wallet system and method which solves the issues mentioned above.

Some embodiments of the present disclosure may incorporate a secure device, which is able to facilitate transfer of cryptocurrency when a user is shopping at a physical or virtual store.

Some embodiments may be able to function without the need to run general purpose software such as operating systems known in the art as IOS, Android or the like. Further some embodiments may be devoid of any logic for installation of new software, and/or may restrict, and or entirely prevent, the installation of new software to ensure maximum virus and malware protection.

One embodiment of the cryptocurrency virtual wallet system and method utilizes at least three keys that are stored in three different locations. For example, three sets of private/public keys may be used with one private key stored on the secure device, one private stored on one or more server configured to communicate with the secure device, and a third private key stored in a secure data vault.

Each key storage location may be secured using a distinct authentication factor. In one embodiment, the cryptocurrency virtual wallet system and method may require N keys out of M keys for completion of a transaction or action where N<=M. In one embodiment, two out of three keys can be used for completion of a transaction or action. Thus, even if the server is compromised, or the secure device is lost, only one of the three private encryption keys is compromised.

Furthermore, embodiments of the cryptocurrency virtual wallet system and method may use multifactor authentication. Multifactor authentication is an approach to authentication which requires the presentation of two or more authentication factors, which generally fall into three categories: a knowledge factor (“something only the user knows”), a possession factor (“something only the user has”), and an inherence factor (“something only the user is”). For example, the cryptocurrency virtual wallet system and method may use biometric authentication technology such that in the event of loss or theft of the secure device, unauthorized access is prevented.

The present disclosure describes an electronic payment system based on cryptographic proof instead of trust. Embodiments of the present disclosure may allow any two willing parties to transact directly with each other without the need for a trusted third party.

The present disclosure may also facilitate transactions that are computationally impractical to reverse to protect sellers and buyers from fraud.

An exemplary embodiment of the present disclosure, provides users with three private keys, each of which is stored in a different location and secured by a different layer of authentication, one of which will be biometric authentications, e.g. fingerprint scans.

In one embodiment, the secure device comprises a wireless transceiver including a dedicated GSM chip, and an embedded multiple IMSI SIM card. Embodiments comprising this componentry may be capable of jumping from carrier to carrier, operate across jurisdictional and international borders, and utilize the carrier services at any particular locate with the strongest network presence.

In one embodiment, the secure device may comprise no exterior ports, no USB ports, no power plug, and no openings. In a further embodiment the secure device includes a casing encompassing the componentry and having an interior volume injected with epoxy resulting in the disabling of componentry in the event of forced entry.

One embodiment of the present disclosure includes the creation and use of three different multi-signature private keys in which none of the private keys can be used individually to enact a transaction. In these embodiments, two or more multi-signature private keys may be used to enact a transaction. A first private key, referred herein as the device key, may be stored on the secure device. A second private key, referred herein as a server key, may be stored on a server. In one embodiment, the server key is stored in an encrypted form, decryption thereof requiring the use of an inherence factor such as biometric data that may be provided via the secure device. A third private key, referred herein as a data vault key, may be stored in offline storage. In one embodiment, the data vault key may be secured by a knowledge or inherence factor (PIN, password, biometric data).

A benefit of embodiments of the cryptocurrency virtual wallet system and method includes the embedding of a first private key in the secure device itself without any logic in the secure device to transmit the first private key so that the first private key is protected by the possession factor. Without having possession of the secure device, there is no way for a third party to obtain the first private key. When you swipe your finger to confirm a transaction, the secure device signs the transaction with its embedded private key and sends the partially signed transaction along with a fingerprint scan to a server. The second private key is stored server-side and if the fingerprint scan is a match, the server countersigns the transaction with the second private key and broadcasts a multi-signed transaction to a cryptocurrency network, such as the Bitcoin network.

Embodiments of the present disclosure may not store fingerprint data on the one or more server. In this arrangement, an embodiment may store a geometric template of the relative locations of unique elements of an authorized user's fingerprint. The geometric template may include the relative locations of bifurcation(s), lake(s), and delta(s), which may be used to validate the fingerprint scan.

An embodiment of the present disclosure may store a fingerprint template, along with other sensitive user data like the second private key in a digital storage element, such as a memory, that is accessible by the one or more server, in an encrypted format. The fingerprint template and the second private key may be encrypted with a key that is referred to herein as a User Data Encryption Key (UDEK). One embodiment may have a unique UDEK for each user.

One embodiment may also store the UDEK on the secure device. In this arrangement, the secure device having a UDEK stored thereon may be required to grant the server temporary access to the associated user data in order for the server to validate the fingerprint scan and sign the transaction with the second private key.

One embodiment of the present disclosure differs from existing cell phone and computer technology in that all connections are initiated from the secure device to the server and the server is outside of the cryptocurrency network. In this embodiment, physical possession of the secure device may be necessary for authentication of a transaction by a user.

A benefit of the present disclosure includes the ability to re-authenticate users, or secure devices in the event of loss or compromise of the secure device. One embodiment includes a third private key and a copy of the UDEK stored offline, which may be used to verify credentials. The use of the third private key plus the UDEK and the server key may be used to meet the two out of three private key multi-signature requirement.

### BRIEF DESCRIPTION OF THE DRAWINGS

FIG. 1 is a front view of an exemplary block card of the present disclosure;

FIG. 2 is a right side view thereof;

FIG. 3 is a rear view thereof.

FIG. 4 includes several images of the block card displaying how the block card may appear when the block card is utilized to send cryptocurrency.

FIG. 5 illustrates a block diagram of an exemplary server and network architecture for an embodiment of the cryptocurrency virtual wallet system in accordance with the present disclosure;

FIG. 6 shows a flow chart of exemplary device connection process flow between a secure device and an API server of the cryptocurrency virtual wallet system;

FIG. 7 and FIG. 8 illustrate a flow chart of exemplary process steps for setting up a secure device for use within the cryptocurrency virtual wallet system;

FIG. 9 illustrates a flow chart showing an exemplary methodology for securing keys within the cryptocurrency virtual wallet system;

FIG. 10 illustrates a flow chart showing an exemplary two factor authentication process for the cryptocurrency virtual wallet system of the present disclosure;

FIG. 11 illustrates a flow chart showing an exemplary receive cryptocurrency process flow for the presently disclosed cryptocurrency virtual wallet system;

FIG. 12 and FIG. 13 are flow charts showing a get cryptocurrency balance process flow for the cryptocurrency virtual wallet system;

FIG. 14 is a flow chart showing an exemplary send cryptocurrency process flow for the presently disclosed cryptocurrency virtual wallet system;

FIG. 15 is a flow chart showing an exemplary buy cryptocurrency process flow for the presently disclosed cryptocurrency virtual wallet system;

FIG. 16 is a flow chart showing an exemplary sell cryptocurrency process flow for the presently disclosed cryptocurrency virtual wallet system; and

FIG. 17 illustrates a functional block diagram for an exemplary embodiment of the secure device of the cryptocurrency virtual wallet system of the present disclosure.

### DETAILED DESCRIPTIONS

All illustrations of the drawings are for the purpose of describing selected versions of the present invention and are not intended to limit the scope of the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Embodiments of a secure device 10, an example of which was referred to as a “block card” in the above-referenced provisional patent applications, may include a physical card structure, be carryable by a user, including in certain embodiments within a wallet or a purse.

As will be apparent to one of ordinary skill in the art of computer security, multi-factor authentication is an approach to authentication which requires the presentation of two or more authentication factors, which generally fall into three categories: a knowledge factor (“something only the user knows”), a possession factor (“something only the user has”), and an inherence factor (“something only the user is”).

The present disclosure describes a cryptocurrency virtual wallet system and method which is designed to be far superior over past and currently available virtual wallet methods. The present disclosure describes both a system and a method which enable it to function. The system of the present disclosure comprises the secure device 10 (an embodiment of which is referred to as a block card), a web portal, a server, and a data vault. The secure device 10 will be described hereinafter with the example in which the secure device 10 is in a card-like configuration. However, it should be understood that the secure device 10 can be provided in other physical forms.

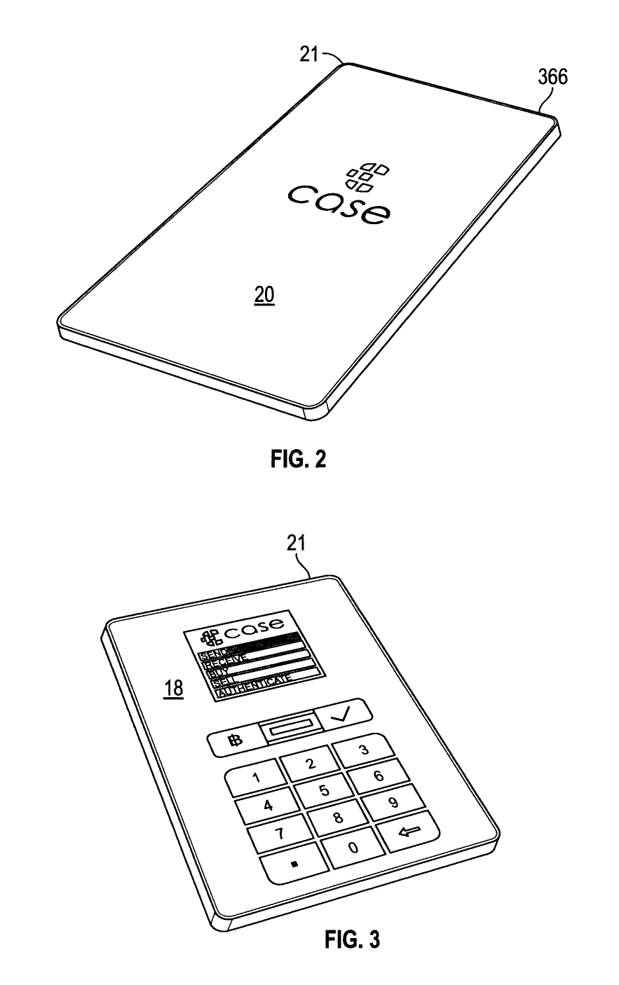

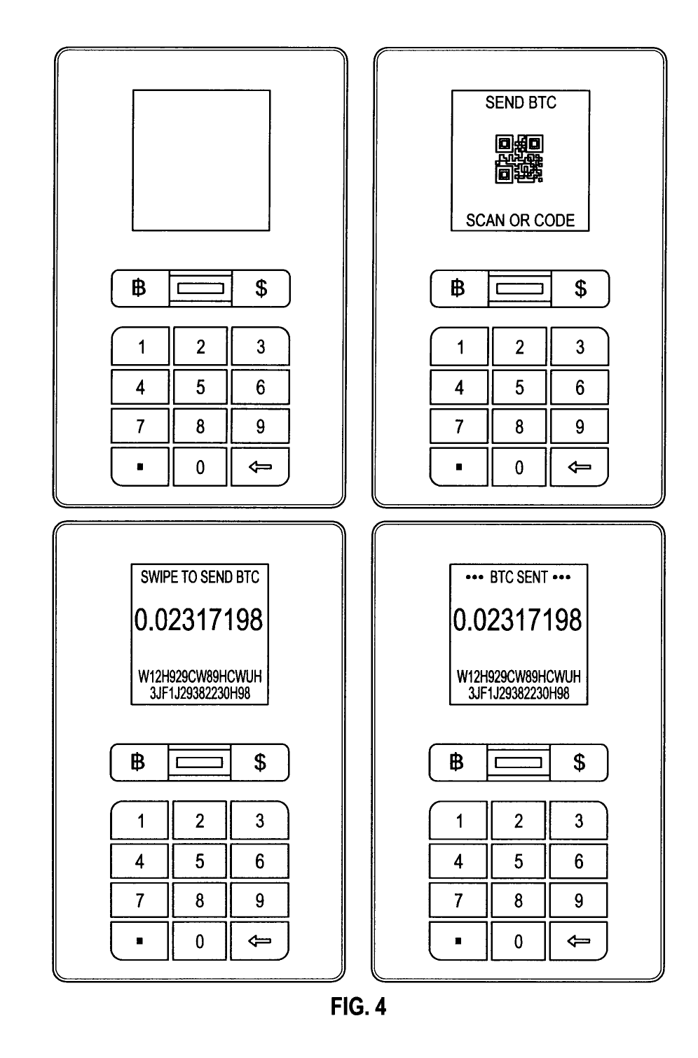

The block card 10 is a physical card structure which can be carried by the user, either in their wallet or purse. The precise dimensions of the block card 10 could vary in the final embodiment of the present disclosure; however, the present disclosure makes use of the standardized ISO/IEC 7810 card size. The block card 10 comprises of components which enable its various different functionalities including a display screen 12, a finger print scanner 14, a key pad 16 including control buttons, a scanner such as a camera 366, a wireless transceiver chip 368 for secure communication with one or more servers over wireless networks, a Magnetic Strip, a microprocessor 360 and a digital storage element that may be incorporated into the microprocessor 360 and combinations thereof. The camera 366 allows the block card 10 accept visual information as input. Although the present disclosure describes the use of the block card 10 with a particular type of cryptocurrency known as Bitcoin, it should be understood that the block card 10 can be used with other types of cryptocurrency. When the block card 10 is designed to be used with Bitcoin, the camera 366 may be necessary as most Bitcoin transactions are carried out at least in part by quick response (QR) codes, although other patterns such as a bar code or textual information can be captured and interpreted by the block card 10. The camera is located on the back of the block card 10 as can be observed in FIG. 2. The exact technical specifications of the camera 366 and its positioning on the block card 10 are subject to change.

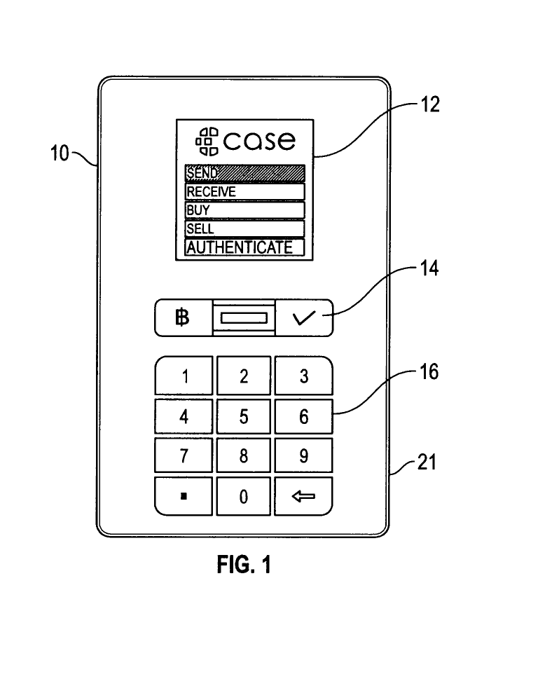

The fingerprint scanner 14 is included with the block card 10 to ensure that only authorized users of the block card 10 are able to actually carry out transactions. The fingerprint scanner 14 is located on the front of the block card 10, as can be observed in FIG. 1, and operates when the user swipes their finger over it. The fingerprint scanner 14 takes a scan of the user's fingerprint, and minutiae from this scan may be utilized in the method of the present disclosure. Although a fingerprint scanner 14 is described herein by way of example, other types of biometric readers can be used, e.g. retina scanner, heart rate monitor, etc., to provide a user verification mechanism and ensure that only authorized users of the block card 10 are able to actually carry out transactions.

The wireless transceiver chip 368 is embedded within the block card 10, and is included to allow for relatively secure wireless communication of data between the block card 10 and the server. In one embodiment, the wireless transceiver chip 368 is necessary for the block card 10 to function, and it is utilized in the method of the present disclosure for sending fingerprint minutiae along with a partially signed bitcoin transaction to the server during certain transactions, along with other communications with the server described herein. The block card 10 may use a multi-band cellular transceiver to connect to the server over 2G/3G/4G cellular networks worldwide but other embodiments may also utilize Near Field Communication (NFC), Low Energy Bluetooth, or another method to communicate transaction information. The exact technical specifications of the wireless transceiver chip 368 are subject to change within the final embodiment of the present invention.

The display screen 12 is located on the front of the block card 10 as can be observed in FIG. 1. The primary purpose of the display screen 12 is to allow the block card 10 to display amounts of bitcoins which are being sent or received by the user, along with wallet balance, currency exchange rates, and other useful information. Additionally, the display screen 12 is responsible for displaying QR codes to be scanned by another device when bitcoins are being sent to the user by another party, such as for a merchant.

The magnetic strip is located on the back of the block card 10 as can be observed in FIG. 3. The purpose of the magnetic strip is to allow the block card 10 to function as a debit card if so desired by the user. As such, the magnetic strip comprises a standard magnetic strip for transfer of information to a point of sale terminal; in one embodiment, the magnetic strip would be almost identical to the magnetic strips found on modern credit and debit cards. Other embodiments may contain a dynamically programmable magnetic strip which can store and use multiple credit or debit cards. Other embodiments might omit the magnetic strip in its entirety using just the QR codes to transfer transaction information.

The block card 10 may use the keypad 16 to receive input from the user, both to control the function of the block card 10 as well as to enter transaction amounts and even passcodes. In the preferred embodiment, there are a pair of control buttons located on the front of the block card 10. Each of the pair of control buttons comprises a physical button which can be depressed by the user. This allows for input into the block card 10 and allows the user to specify which functionality of the block card 10 they would like to activate at any given time. In order to minimize the likelihood of accidental activation of the block card 10, the control buttons may function as both capacitive touch buttons and physical buttons. When the user depresses the physical button, it temporarily activates the capacitive touch surface of the button to ensure that the button was depressed by a finger or other capacitive object. One of the pair of buttons is marked with the indicia of some kind of cryptocurrency, bitcoins in the case of the preferred embodiment. And the other of the pair of buttons is marked with the indicia of some government currency, dollars in the preferred embodiment. The pair of buttons is utilized in the method to activate various different functions of the block card 10. Directly related to the pair of buttons is the keypad 16, which is located just below them as can be observed in FIG. 1. The keypad 16 may comprise a standard numerical keypad, and enables entry of numbers into the block card 10. This allows the user to specify amounts of cryptocurrency that they wish to send, receive, buy, or sell when performing transactions with the block card 10.

The digital storage element is embedded into the block card, and is responsible for providing digital storage space for one of the encryption keys which represent the user's bitcoins, as well as storing other user information such as the User Data Encryption Key (UDEK). As mentioned, only one of the three encryption keys is stored on the digital storage element, thus preventing compromise of the user's bitcoins if the block card 10 is ever lost or stolen. Directly related to the digital storage element is the microprocessor 360. The microprocessor 360 is responsible for providing the computing power necessary to perform the several functions of the block card 10 such as signing transactions with the encryption key, breaking down the fingerprint scan into minutiae which can be sent to the server, generating QR codes to receive certain amounts of bitcoin from other parties, and interpreting scanned QR codes to send bitcoins to other parties.

The web portal provides certain pertinent information to the user such as the current account balance, transaction history, and account information. Furthermore, the web portal enables the user to control certain aspects of their account such as the contact information or any bank account information associated with the account. In order to login to the web portal, the user is required to utilize the block card 10 to receive a one-time password and then enter this one time password into the web portal in addition to other authentication factors such as a password. This provides authentication that the user attempting to log in to the web portal is the true owner of the block card 10. The embedded wireless transceiver 368 and the embedded encryption key allow for multiple methods of secure multi-factor authentication which are not possible with traditional one time password generators. One embodiment involves receiving a one-time key, also known as a challenge, from the web portal. This challenge can be communicated to the block card 10 as simple numeric data that the user manually inputs using the keypad 16. The challenge can also be sent to the block card 10 as complex alphanumeric data that is input by scanning a QR code with the embedded camera or sent directly from the server using the embedded wireless transceiver 368. This challenge is then signed using the embedded encryption key and the signed challenge can either be sent to the server in order to provide a second authentication factor in addition to the username and password already entered on the web portal login page, or as a second and third authentication factor if the signed challenge is sent along with a fingerprint scan to provide both possession and inheritance authentication.

The Server is an important part of the present invention, and maintains a connection to the Internet. The primary purpose of the server is to store one out of three of the encryption keys which represent the user's bitcoins. Additionally, the server stores fingerprint minutiae data in order to compare to information sent to the server from the block card (the inheritance factor). The fingerprint scanner on the block card 10 is used to authorize that the true owner of the bitcoins is attempting to make a transaction with the block card 10. The server is also responsible for facilitating transactions, and therefore performs the typical functions of a bitcoin wallet including keeping track of unspent balances, structuring transactions, signing transactions, and broadcasting fully signed transactions to the Bitcoin network. The block card 10 acts as a co-signing device in conjunction with the bitcoin wallet on the server. In order to create a relationship between the block card 10 and server that is as secure as possible, the present disclosure creates an environment where the block card 10 and server don't trust each other during a transaction to ensure that there is no single point of failure. When the block card 10 requests to send a specific amount of bitcoins to a specific address, the server validates the request by comparing the fingerprint scan sent by the block card 10 against the server stored fingerprint template. The server only creates an unsigned transaction and sends it to the block card 10 if the fingerprint scan matches. The block card 10 validates that the transaction it is being asked to sign is the transaction it intended to perform by verifying the receiver address and amount, along with the change address, which should be controlled by the block card owner. The block card 10 then signs the transaction with its embedded encryption key and sends the partially signed transaction to the server. The server signs the transaction with its encryption key if the fingerprint matches the server stored fingerprint template, and this creates a co-signed transaction that is then broadcasted to the Bitcoin network by the server, so that bitcoins are sent to the intended recipient, thereby completing the transaction. This server may be a single server system or the varied functionality required may be broken up over multiple servers. Multiple servers offers numerous advantages including additional ability to firewall servers whose functions do not require a direct connection to the Internet as well as the ability to better scale operations as use of the various servers increase. In the preferred embodiment, the Server has been broken into the following distinct server functions: the API Server, which is responsible for receiving and routing the various program interface calls from the block card 10 and other servers; the User Account Server (UAS), which is responsible for storing the user's account information, such as devices owned, personal contact information, etcetera; the Wallet Server, which is responsible for performing the cryptocurrency related functions, such as signing the transactions and broadcasting them to the cryptocurrency network; the Message Server, which is responsible for sending information to the user through alternate communications means such as emails or text messages; and the Web Portal Server or Web Server, responsible for providing a web portal front end to the user, as described above. One skilled in the art will understand that the server has one or more processors and one or more non-transitory computer readable medium, e.g., memory, storing logic that when executed by the one or more processors cause the one or more processors to perform the functionality described herein.

The server bitcoin wallet is also designed to make accounting and tax preparation simpler. Since bitcoin transactions are publicly visible on the block chain ledger, many users generate a new private encryption key, and therefore a new public bitcoin address, for each transaction so that the full balance of their bitcoin wallet isn't known to those they transact with. These encryption keys may be generated randomly or they may be derived from a master key. Each key can also spawn its own chain of derived keys and this is known as a hierarchical deterministic wallet. Since the block card uses three encryption keys to secure the wallet, one or more of them are cycled down a deterministic chain. In the preferred embodiment, instead of cycling down one deterministic branch, it cycles down three branches. The addresses generated on one branch are only used for receiving bitcoins. The addresses generated on another branch are only used for buying bitcoins. The addresses generated on the third branch are only used as change addresses, which receive the unspent portions of transaction inputs. By segregating transactions in this way, the wallet architecture itself, as stored on the block chain and without additional logging data, can provide information on when and how many bitcoins were bought, when and how many bitcoins were received, and when and how many bitcoins were sent, while isolating bitcoins that were received from oneself as change from unspent portions of transactions. This information is useful for both accounting and tax purposes.

The data vault provides physical or digital storage and stores one out of three of the user's encryption keys for their bitcoins. The data vault is not directly connected to the Internet in order to drastically reduce the possibility for its compromise. The purpose of the data vault is to ensure that the user can retrieve their bitcoins even if the block card is ever lost or stolen. Because of the intended use of this third key it is often referred to as the “Recovery Key,” since it is used to recover access to funds controlled by the block card 10 if one of the other primary keys is lost or stolen. In the preferred embodiment, this recovery key is stored off-line, meaning it is not connected to the network in any way, and is only accessed when needed using the recovery procedures described below. Since the data vault stores one of the encryption keys, and the server stores one, the user still has two out of the three encryption keys needed to utilize those bitcoins in a transaction even despite the loss of the block card 10. Of course, the user would be required to provide certain identifying information (knowledge factor) in order to authorize the use of encryption keys from the data vault. Regardless, this failsafe helps to increase security of the presently disclosed inventive concepts and reduce the risk of the user losing their bitcoins and money.

The method of the present disclosure comprises a plurality of interactions between the components of the system which enable various different functions to be carried out. It is accepted that the order of the steps could be altered in the final embodiment of the present disclosure and still obtain the same desired functionality. The method in the preferred embodiment of the present disclosure comprises the following steps:
1) For any currently owned bitcoins of the user, one of the three encryption keys is stored on the block card 10.
2) One of the three encryption keys is stored on the server.
3) One of the three encryption keys is stored on the data vault.
4) When the user wishes to send bitcoins to another party, be it an individual or a merchant, the user clicks on the button which is marked with the bitcoin indicia, which causes the block card 10 to activate the camera 366 in preparation of scanning a quick response (QR) code.

5) The user scans the QR code of the recipient by using the camera 366 and enters an amount of bitcoins they wish to send if the QR code does not include an amount in its encoding.

6) The user swipes their finger across the fingerprint scanner 14 to authorize the transaction. Minutiae obtained from the fingerprint scanner 14 is extracted and sent to the server for authentication. The block card 10 also signs the transaction using its stored encryption key and sends the signed transaction to the server via the wireless transceiver chip 368. Assuming successful authorization based on the fingerprint minutiae, the server completes the transaction by signing it with its encryption key and broadcasting the co-signed transaction to the Bitcoin network, thereby transferring the bitcoins to their new owner.

7) To receive bitcoins, the user clicks the button marked with the bitcoin indicia twice in rapid succession.

8) The user enters the amount of bitcoins they wish to receive, and swipes their finger across the fingerprint scanner 14 to provide authentication.

9) The block card 10 shows a QR code which anyone can use to send the designated amount of bitcoins to the block card user.

10) In order to buy new bitcoins using the block card 10, the user clicks the button marked with the bitcoin indicia three times in rapid succession.

11) The user enters the amount of bitcoins they would like to buy or the amount of fiat currency they wish to convert, and swipes their finger across the fingerprint scanner 14 to provide authentication.

12) The server automatically buys the designated amount of bitcoins utilizing funds from a linked bank account.

13) In order to sell bitcoins using the block card 10, the user clicks the button marked with the bitcoin indicia four times in rapid succession.

14) The user enters the amount of bitcoins they would like to sell, and swipes their finger across the fingerprint scanner 14 to provide authentication.

15) The server automatically sells the designated amount of bitcoins on a bitcoin exchange and deposits the obtained funds into the linked bank account.

16) In order to log into the web portal, the user must obtain a one-time password using the block card 10. To trigger this, the user presses both buttons at the same time, one button being marked with the bitcoin indicia and the other being marked with the dollar indicia.

17) The challenge is received by the block card 10 through manual keypad input, camera QR code scan, or wireless transceiver.

18) The user swipes their finger across the fingerprint scanner 14 to provide authentication, and the one-time password appears on the display screen 12 of the block card 10 or is transmitted directly to the server using the wireless transceiver 368.

19) In order to utilize the block card 10 as a debit card, the user presses the button marked with the dollar indicia, thereby preparing the block card 10 for use as a debit card.

20) The user swipes their finger across the fingerprint scanner 14 and pending authorization from the server, the block card 10 is now able to function as a debit card.

21) The user utilizes the block card 10 as a debit card, and the proper amount of bitcoins are automatically liquidated by the server in order to pay for the transaction in dollars instead of bitcoins.

This functionality represents a significant step forward in security and ease of use of cryptocurrency as it is the first successful combination of a number of new technologies into a single small, easy to use, and portable secure device 10 that functions as a virtual wallet for cryptocurrency. Multi-signature address generation, hierarchical deterministic key generation, multi-factor authentication, trustless communication between the secure device 10 and the server systems, and an embedded system secure device 10 provides numerous layers of security, both in terms of protecting against loss and theft as well as privacy. The QR code capability of the camera 366 and display screen 12, the use of the fingerprint scanner 14 (or other form of biometric authentication) for authorization, a wireless communication system to allow for independent use anywhere cellular coverage is available, and a well-designed work flow combine to make the secure device 10 convenient and easy to use.

The multi-signature address generation, described above, can be in any form of “N of M keys” where N<M and where N is the number of keys required to sign the transaction in order to authorize it and M is the total number of potential keys that can be used to sign the transaction. In the preferred embodiment the values of N=2 and M=3 was used, or a 2-of-3 multi-signature scheme, is used as this provides protection against losing a single key, allows for a recovery key to be stored offline, without introducing so many keys as to become cumbersome, but a 3-of-4 or 3-of-5 multi-signature scheme could also be used with the additional keys being stored on additional servers or additional secure devices. While the additional keys could be stored on the same server or the same secure device, this offers no additional security advantage over the 2-of-3 multi-signature scheme since the extra keys are lost at the same time the server or the secure device are lost or compromised.

The hierarchical deterministic key scheme allows the user to generate unique public keys, referred here as “sub-keys,” for use in the bitcoin addresses to receive bitcoins thus protecting the privacy of the user by not associating the transactions with each other. The hierarchical deterministic nature of the keys allows the server to more readily gather up all of the “sub-keys” to more easily produce transaction history for the user.

The multi-factor authentication scheme provides additional security for the user should he lose the secure device 10. The communication to the server is protected by use of the fingerprint data (an inheritance factor) and/or a passcode (a knowledge factor) in addition to the device information itself (a possession factor). Securing the communication to the server protects the cryptocurrency from theft and taking full advantage of the multi-signature scheme since these authentication factors have the server sign the transaction with the signature key stored there.

In some embodiments, the trustless communication scheme defuses some common malicious attacks on device-server communications. In many systems, a trusted communication scheme is used where the server is either set up as a trusted site or establishes itself as a trusted site. While this makes communication between the device and the server easier, it makes the system vulnerable to attacks that can present an alternate server as the trusted site and thus gain access to the information on the device. It also makes the communication vulnerable to “man in the middle” attacks where a malicious system on the network intercepts the network packets being sent from the server to the device, changing a few key parameters in the packet, and then sending the packet onto the device where the device mistakenly believes the information from the server to be correct and acts on it, or vice versa when intercepting packets sent from the device to the server. In one embodiment, the trustless communication scheme can be maintained in a number of ways. First, the secure device 10 may encrypt all of its data being sent using a User Data Encryption Key (UDEK). Any data that remains stored on the server stays encrypted by this UDEK even though the server never stores the UDEK. This means that the information can only be decrypted when in communication with the secure device 10. The user data and UDEK are then combined and encrypted again using a Shared Private Key (SPK), which is a key shared by the secure device 10 and the server. This doubly encrypted packet may then be sent to the server through a Secure Socket Layer (SSL) affording even more security of communications. The server may use its copy of the SPK to decrypt the packet and then may use the UDEK to decrypt any user data needed for the specific transaction, including the multi-factor authentication sent with the packet. The server may only use the information if the multi-factor authentication information matches what is stored on the server (after being temporarily decrypted using the supplied UDEK). If the packet sent to the server includes a transaction request, such as a request to send bitcoin, then the server acts on that request and builds an initial transaction. The information is also encrypted with the UDEK, combined with the server authentication information, encrypted with the SPK, and sent back to the secure device 10. After decrypting the packet, the secure device 10 confirms the server authentication data and decrypts the user data. The secure device 10 then validates that the critical information, such as destination bitcoin address and transaction amount in the “send bitcoin” example, contained in the initial transaction matches the information that was put into the original transaction request. In one embodiment, if any of the authorization fails or any of the information does not match up, the user may be warned and the transaction does not proceed.

The embedded system scheme increases the security of the overall system by only allowing the proscribed communication schemes defined by the protocols of the system. For virtual wallets running on general purpose computing devices, such as personal computers, servers, laptops, tablets, smartphones, and other similar devices, the systems are prone to attacks through any of the thousands or hundreds of thousands of communication ports open on those systems. Malicious software could be running in the background and capture all keystrokes, this capturing passwords or passcodes, or could create man-in-the-middle attacks by intercepting network packets. In one embodiment, the secure device 10 has no such general purpose use, these additional ports are not present and there is no ability to run additional software, in the foreground or the background.

The ability of the secure device 10 to both scan and display QR codes is an optional feature that greatly increases the utility and ease of use of the system. The ability to scan QR codes allows the device to easily capture the “send destination” cryptocurrency address and transaction amount at a point of sale terminal or other software that can present this information. The ability to display QR codes allows the device to easily transmit a “receive destination” cryptocurrency address when someone is attempting to send bitcoins to the user's wallet. When combined with the wireless communications capability, this allows the secure device 10 to be used in a store in much the same way as a credit card. This functionality could be further enhanced by the use of a programmable magnetic strip that allows the information to be sent through a magnetic strip in much the same way as a debit card transaction takes place enabling it to work in places where only national currency is taken, however the QR code capability alone provides plenty of ease of use for cryptocurrency transactions.

The fingerprint scanner 14 provides another optional but quick and easy methodology to provide authorization information to secure the transaction. Combining this fingerprint scan with a passcode entered on the keypad 16 provides an additional layer of security by adding another factor of authentication. A well-designed workflow means the user need only perform three functions using the above capabilities to complete a transaction such as a bitcoin purchase. 1) Use the camera 366 to scan the QR code containing the merchant's destination bitcoin address and dollar amount. 2) Verify the amount on the display screen 12 and if it is correct, swipe a finger on the fingerprint scanner 14 to authorize. 3) Wait while the wireless communications system connects, transmits the transaction request to the server, receives the initial transaction, verifies it, signs it, and sends it back to the server for additional signing and transmittal to the bitcoin network. This last step all happens automatically unless any one of the numerous security checks and validations fail.

The preferred embodiment of the secure device 10 is used to perform cryptocurrency transactions, and more specifically, bitcoin transactions, but the same protocol can be modified for additional uses, especially ones involving transactions. For instance, the secure device 10 could be used to allow the user to securely make stock exchange transactions. Today's systems typically utilize a web site with a simple password or perhaps an additional security device that provides a synchronized passcode that must be entered when logging in. The additional security features of the secure device 10 could be used to ensure it truly is the owner of the stock initiating the requested stock transactions.

The inclusion of a third key can be used for recovery purposes should one of the primary keys be lost or compromised. Security protocols for this third key can be no less stringent or else it weakens the security of the overall system since if the third key is easy to obtain with either of the other two then the large added security benefit of the 2-of-3 multi-signature scheme is lost. As such, as part of this system, a stringent protocol has been defined to ensure that the recovery key is kept securely and is only accessed when authorized by the user but is done so in a manner that does not present too difficult a burden for recovery. [Insert protocol here.]

The preferred embodiment of the secure device 10 can be considered to be an embedded system secure device. It should be understood that the secure device 10 can be provided in other forms. For example, an embodiment of the secure device 10 could be a smartphone application that performs the security schemes and protocols described above to perform this same capability. In that embodiment, the only security scheme not present from the preferred embodiment would be the additional security of the embedded system secure device. However, the user may opt to forgo this additional security feature, in light of all the other security features of the system and in light of the additional convenience of having a secure virtual wallet on the smartphone instead of on an additional secure device.

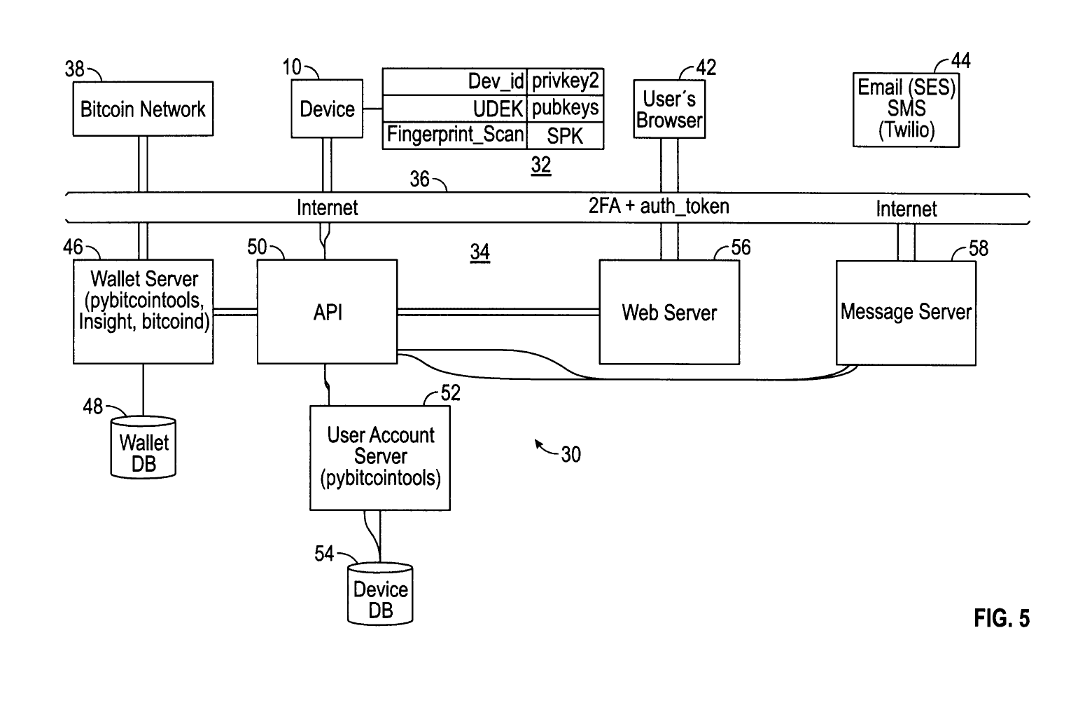

Referring now to FIGS. 5-16, various embodiments of a cryptocurrency virtual wallet system 30 will be described. FIG. 5 illustrates a block diagram of an exemplary embodiment of the cryptocurrency virtual wallet system 30 in accordance with the present disclosure. The cryptocurrency virtual wallet system 30 includes network side 32, and server side 34, both of which interface with the internet 36 or other suitable network for facilitating transactions. Network side 32 includes a cryptocurrency network 38 coupled with the internet 36, which is shown by way of example as Bitcoin network. Secure device 10 may include at least 3 levels of security. A private key within the secure device 10, a public key, and then an SPK key associated with the user's fingerprint scan. A user's browser 42 may interface with internet 36 on network side 32, as does email and SMS text messaging, to facilitate communications.

Server side 34 includes wallet server 46. When the cryptocurrency is Bitcoin, wallet server 46 includes ‘pybitcointools’, insight, and Bitcoin D information which may be stored and retrieved from wallet database 48. Wallet server 46 further communicates with API server 50. API server 50 interfaces with user account server 52 for pybitcointools, which user account server (UAS) 52 stores and receives from device database 54. API server 50 communicates with web server 56 as well as message server 58. Message server 58 further interfaces and communicates with internet 36. Message server 58 also communicates with internet 36.

On server side 34 wallet database 48 includes a number of lookup tables, including but not limited to child key tables, a self-healing flag table, a lock table, and a transaction table. The child key table includes information such as keys to communicate only on the server branch side, as well as information such as a most recent knowledge of the contents of the wallet database 48 and how recent the current knowledge of the contents may be. The self-healing flag determines whether self-healing is necessary to perform, while the lock table includes data associated with how and when the secure device 10 may have been locked. The transaction table within wallet database 48 stores and provides cryptocurrency addresses, such as Bitcoin addresses, of a transaction sender as well as public key information of importance for facilitating the transaction. The transaction table may further include amount sent in a transaction, the non-user recipient address in the transaction, and the user's own recipient address may be included. The transaction table may further include the amount sent to the recipient address and any change address. Furthermore, a timestamp as to when the transaction is broadcast to the cryptocurrency network 38 and whether the transaction has been pushed as well as the cryptocurrency transaction's specific identifier.

Device database 54 includes a device table storing a device identifier which may be a primary key for the device table, a unique serial number associated with the secure device 10, and a shared private key between the secure device 10 and the user account server 52. The shared private key may potentially be updated in the event of a breach. Device table may further include the server's private key which is used for signing transactions. Device table may also store public keys 1, 2 and 3 and user's fingerprint template, all of which may be encrypted with the UDEK. The user's fingerprint template may be stored in the device table to authenticate against before spending. A timestamp for the latest successful operation of the secure device 10 may be stored in the device table. Device table may also store an operation to continue after a 2FA process, a number of fingerprint failures that have occurred since lockout time, as well as the time after which the secure device 10 is “unlocked” for use again.

Device database 54 may also include a web table storing a person's name which may be defined as an email address for the user to force uniqueness, identification of the secure device 10 associated with the user's account, and a password salt for checking password correctness is included in the web table. A “password salt” is a method for protecting the identity of a password that is known by those skilled in the art of cryptography. A hashed password is provided with the verification salt, the encryption salt provided for generating a public key encryption key. Public keys 1, 2 and 3 are stored within the web table for the user and may be encrypted with a Password-Based Key Derivation Function 2 (“PBKDF2”) password and the encrypted SALT. A code may be displayed to a user by the web server 56, that should be entered in the secure device 10. Also, a temporary slot for PBKDF2 password and encryption SALT is provided for the time between decryption and encryption during first time startup. An integer representing how far along a user is in their setup process is provided as well as from the initial registration, email verification, phone verification, etc., this information is provided for verification. Web table may also include an integer representing a status of the secure device 10. For example, the integer may be a numeral 0 to represent that the device database 54 is not completely linked to the secure device 10, and a numeral 1 to represent that set up is complete and the device database 54 is completely linked to the secure device 10 and that 2FA is successful.

As additional examples, an integer 2 may represent that a fingerprint is registered and an integer 3 may represent that public keys are re-encrypted and that all is done in the process. The web table may also store a timestamp for the latest successful operation for the web user as well as an optional user's phone number. Device database 54 may further include a ‘resets table’ which may be used during a ‘forgot password flow’ after email verification to stage changes until the user authenticates using the secure device 10. The resets table may include the email address of the user in question and the device ID identifier of the user in question. The resets table may also include a hash of the user's new password that may be used to log in to the web server 56. The resets table may also include a new encryption key based on the user's password as a temporary password used to encrypt the user's public key for the web server 56 after a successful 2FA. The time at which the user verified they were in control of their email address may also be stored in the resets table. Finally, the resets table may include a 2 factor code that will be entered into the secure device 10 in order to 2FA the given user.

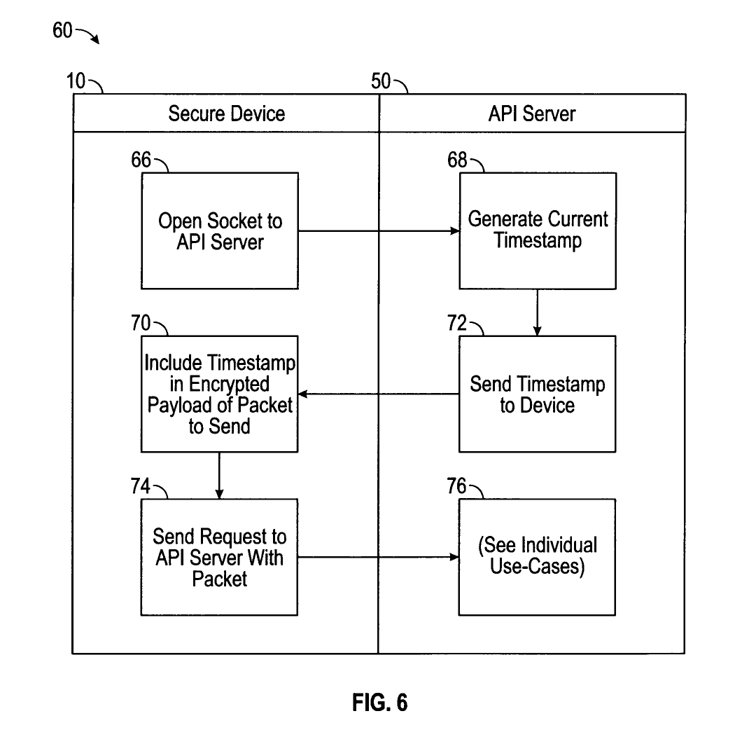

FIG. 6 shows a process flow 60 for establishing a secure connection between the secure device 10 and the API server 50. This includes actions on both the secure device 10 and the API server 50. To establish the secure connection, a first step 66 includes opening a socket to the API server 50. Next at step 68, API server 50 generates a current timestamp. Then, at step 72, the API server 50 sends the current timestamp to secure device 10. At step 70, the secure device 10 includes the current timestamp in an SPK-encrypted data of a packet. At step 74, the secure device 10 sends a request to the API server 50 with the packet. The request is sent and, at step 76 various individual case uses apply as will be described below.

The timestamp is included in the SPK-encrypted packet to prevent a replay attack; an attacker can modify the timestamp to a later date without also knowing the SPK. The timestamp is verified before the device database 54 is ever modified. The process flow 60 checks that the timestamp is newer than the timestamp currently stored in the device database 54 under the device ID of the user device 10. Process flow 60 then checks that the timestamp is “roughly” the current time (e.g. global GMT time). The second check ensures that an attacker cannot insert an incorrect time through process flow 60, either too early or too late. The first check (plus the assurance of the second check) ensures that no properly encrypted transaction may be stored and then replayed. This is true even if HTTPS is broken.

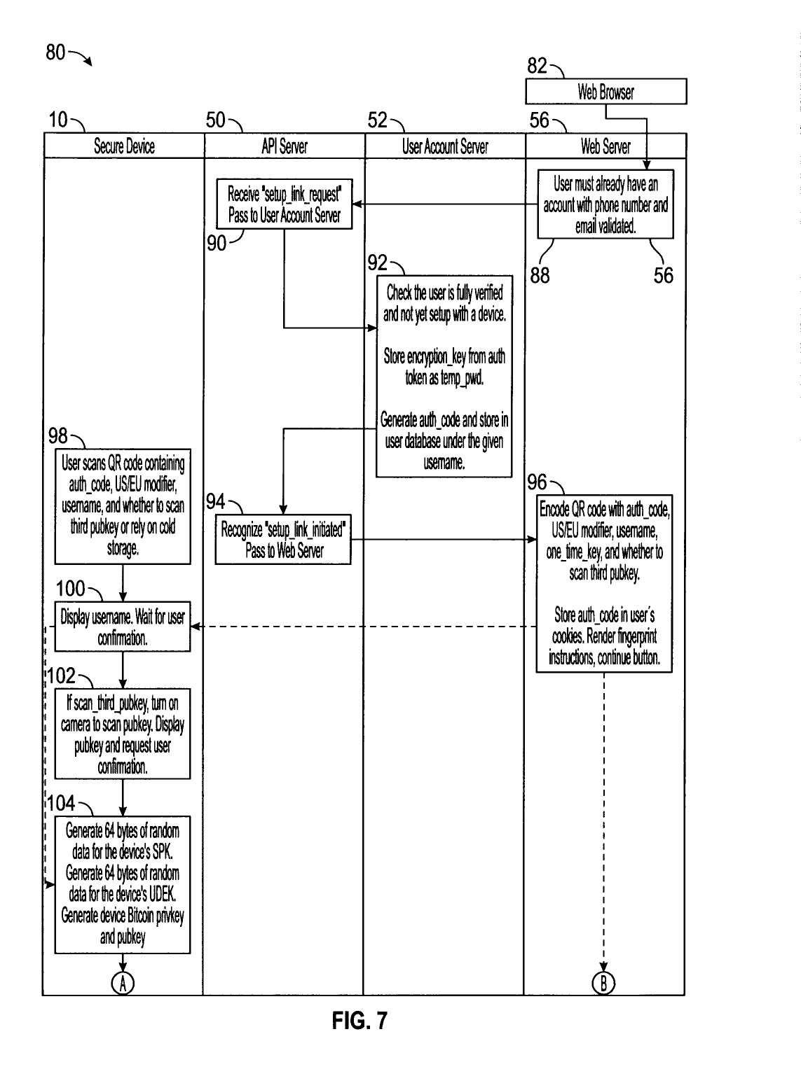

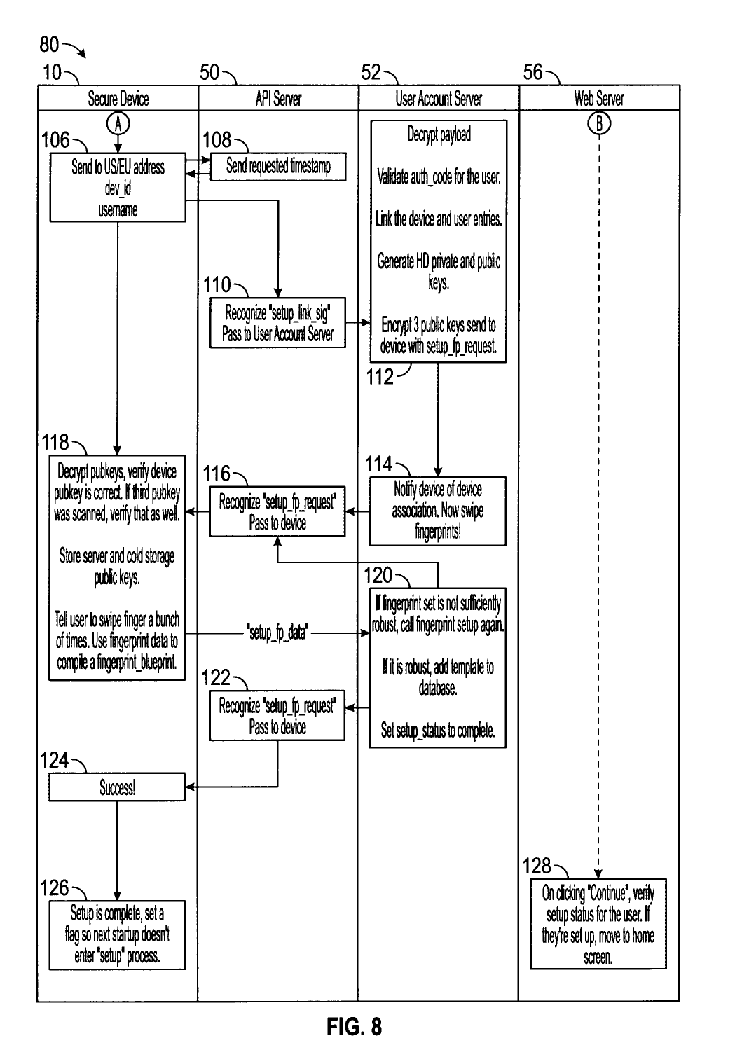

FIG. 7 and FIG. 8 illustrate an exemplary process flow 80 for use case ‘first time setup’ which establishes the setup parameters for the present disclosure. First time setup begins at step 82 where web browser 42 communicates to begin web server process flow 86. First time set up process flow 80 includes process flow occurring at secure device 10, API server 50, user accounts server 52, and web server 46. From step 88 comes a send command including user name, an authorized token for the user account server 52, and an ‘opt_setup link’ request. From step 88, process flow goes to API server 50 to execute a step 90 in which API server 50 receives a “setup link request” to pass to the user account server 52. At the user account server 52, step 92 includes checking that the user is fully verified and not setup with a secure device 10. At step 92, user account server 52 stores the encryption key from the authorized token as a temporary password. Next, user account server 52 generates an authorization code and stores the code in the device database 54 under the given user name. User account server 52 then generates 64 bytes, for example, as a one-time key, and encrypts the one-time key with a master SPK. Then user account server 52 stores the encrypted one-time key in a temporary one-time key field. Finally, user account server 52 sends the user name, authorization code and the one-time key to the internet 36. Process flow then proceeds to step 94 at API server 50 which recognizes the setup link initiated command and passes that to web server 46 at step 94.

Step 96 occurs at web server 46 upon which web server 46 encodes a QR code with the authorization code, country modifier indicative of a country where the secure device 10 is located such as the US/EU, user name, a one-time key and whether to scan for a third public key. Web server 46 then sends a packet to the secure device 10 to store the authorization code in the user device's cookies and to prompt the secure device 10 to continue the setup process.

Continuing to step 98, secure device 10 captures an image of a QR code containing a authorization code with the camera 366, a US/EU modifier , a user name, and whether to scan a third public key, or rely on cold storage.

Continuing to step 100, secure device 10 displays the user name and waits for confirmation.

Continuing to step 102, secure device 10 determines that if there is a scan for public key to turn on the camera 366 to scan the public key. And then further display the public key and the request for user confirmation. At step 104, secure device 10 generates 64 bytes of random data for the secure device 10 SPK. Secure device 10 generates 64 bytes of random data for the secure device 10 UDEK. Further, secure device 10 generates a device Bitcoin private key, for example, and public key and then further decrypts a one-time key with a master SPK.

Note that at web browser 82 there may be the need to be able to reset a secure device 10 again through the web portal if someone wants to give away their secure device 10 to another person.

FIG. 8 continues first time setup process flow 80 from FIG. 7. At step 106, secure device 10 sends to US/EU address: a plain text developer ID and a user name with information including the UDEK, a setup link signature, a timestamp, SPK, the user name, authorization code, device public key, and a third public key. In addition, process flow continues from step 106 to step 118 which will be described shortly. At step 108 a send request timestamp is sent to API server 50 which timestamp is sent to secure device 10. From secure device 10 step 106, process flow continues to step 110 where API server 50 recognizes the setup link signature and passes that information to the user account server 52. From step 110 process flow continues to step 112 where user account server 52 decrypts the data with a one-time key. User account server 52 validates the authorization code for the user and links the secure device 10 and user entries. Next, user account server 52 generates HD private and public keys. Step 112 further includes encrypting three public keys with the UDEK, and storing the secure device 10 in the device database. The user account server 52 encrypts three public keys with a temporary password and stores this information in the device database 54. Finally, at step 112, user account server 52 encrypts the UDEK-encrypted public keys with SPK and sends that information to the secure device 10 with setup FP request.

Process flow then continues to step 114 wherein user account server 52 notifies secure device 10 of its association with the one or more servers 46 and 52. Now, the user needs to swipe for his fingerprint. At this point, process flow continues to step 116 at API server 50 where API server 50 recognizes the setup FP request and passes that information to secure device 10.

At step 118 secure device 10, having received input from step 106 decrypts the public keys, verifies the device public key is correct. If a third public key was scanned secure device 10 verifies that as well. Then, secure device 10 stores server and cold storage public keys. Secure device 10 then tells the user to swipe his finger a predetermined number of times on the fingerprint scanner 14, which can be How many times?. The secure device 10 then uses fingerprint data to compile a fingerprint blueprint or template. The secure device 10 then sends a command to user account server 52, which user account server 52 receives at step 120. If the fingerprint template is not sufficiently robust, user account server 52 calls for fingerprint setup again with UDEK- encrypted public keys. Conversely, if the fingerprint template is sufficiently robust, user account server 52 encrypts the fingerprint template with the UDEK and then adds the fingerprint template to the device database 54. Next, at step 120, user account server 52 determines that the setup status is complete. Process flow then continues to API server 50 at step 122. At step 122 API server 50 recognizes the setup fp success state and passes that to secure device 10. At step 124, the secure device 10 receives the fingerprint setup success signal and then, at step 126, indicates that setup is complete and sets a flag so next startup doesn't enter the setup process.

Note that step 128 which receives input from step 96 at web server 46, takes the step that on clicking “continue” web server 46 verifies the setup status for the user. If the secure device 10 is set up, then the web server 56 supplies a home screen to the web browser 82.

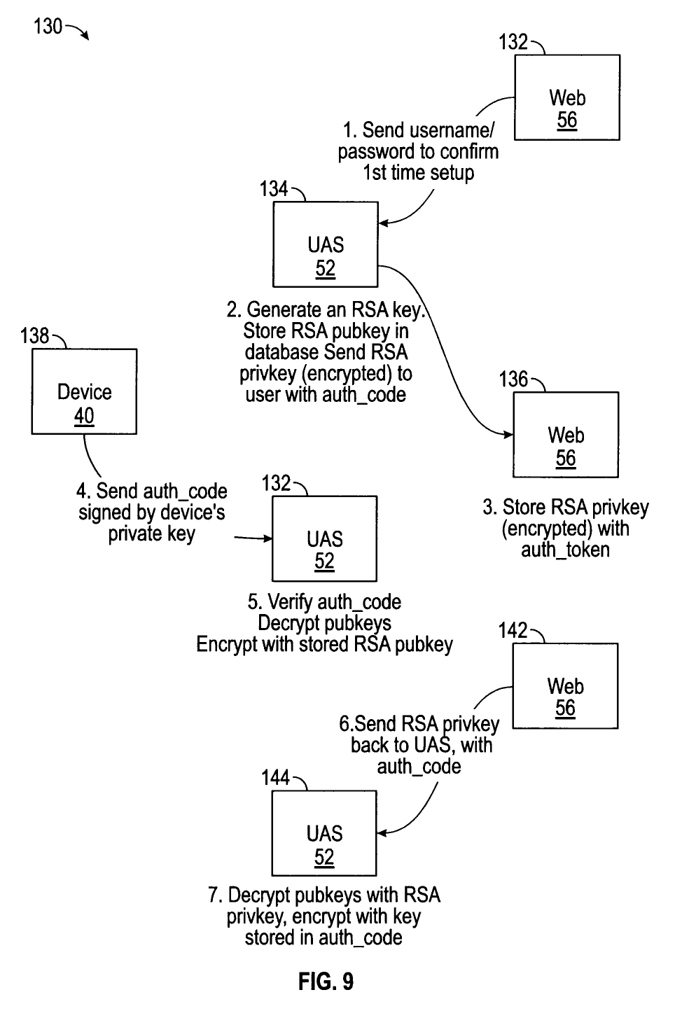

FIG. 9 illustrates an exemplary ‘public key syncing’ process 130, which may be a subset of the ‘first time set up’ function. Public key syncing process 130 highlights the encryption processes that occur to keep the private key/public key secured. At step 132, web server 56 performs a first step to send username and password to confirm a first time set up. This may include a serial number for a particular secure device 10. At step 134, user account server 52, in response generates an RSA key from the password deterministically, for example. User account server 52 stores an RSA public key in the device database 54 and sends an encrypted RSA private key to the user with an authorization code via the web server 56. At step 136, web browser 82 further stores the RSA private key, again encrypted, with the authorization token. At step 138, secure device 10 sends an authorization code that is signed by the private key of the user device 10. The authorization code is sent to the user account server 52, which at step 132 verifies the authorization code and decrypts the public keys with the UDEK. Further user account server 52 encrypts the public keys with the stored RSA public key.

Further, the user account server 52 encrypts the authorization code with the stored RSA public key. At step 142, web server 56 sends the RSA private key back to the user account server 52 with the authorization code, furthermore, the user account server 52 decrypts the public keys with the RSA private key, encrypts the public keys with the keys stored in the authorization code.

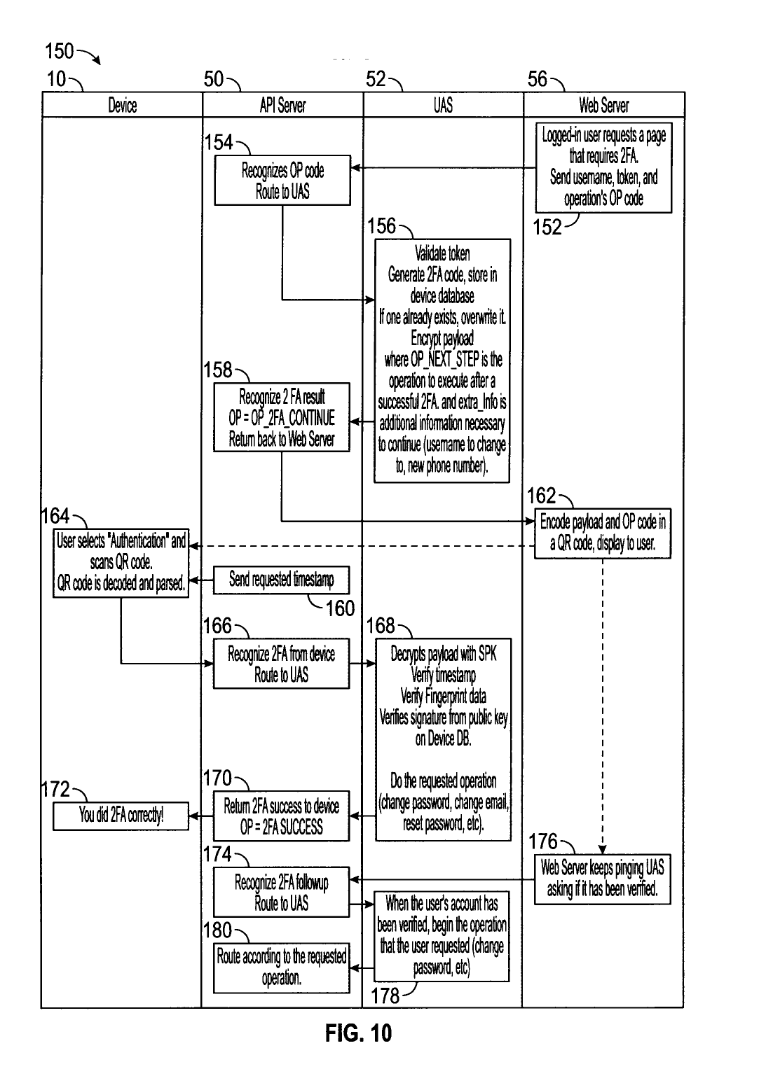

FIG. 10 illustrates an exemplary multi-factor authentication process 150 for secure device 10 of the present disclosure. The multi-factor authentication process 150 will be described hereinafter as using a two factor authentication. However, it should be understood that additional factors could also be used. The multi-factor authentication process 150 begins at step 152 when a logged in user requests a page that requires two factor authentication (2FA).

In response web server 56 sends a user name token and operations OP code to API server 50. At step 154 API server 50 recognizes the OP code and routes the request to the user account server 52. At step 156, user account server 52 validates the token and generates a 2FA code and further stores the 2FA code in the device database 54. If a 2FA code already exists, user account server 52 overwrites the 2FA code. User account server 52 further encrypts the data with the shared private key, SPK, for example.

The data at this step includes the OP next step, the 2FA code and extra info. The OP next step is the operation to execute after a successful 2FA. The extra information is additional information necessary to continue such as user name to change to a new phone number, etc.

From step 156, the multi-factor authentication process 150 proceeds to step 158 wherein API server 50 recognizes the 2FA result and produces an OP code of OP-2FA-continue. Then process control returns back to web server 56 for performing step 162. At step 162 web server 56 encodes the data and the OP code in a QR code and displays that code to the user. Thereafter, web server 56 sends information to the secure device 10.

At step 164 a user selects an authentication and scans the QR code. The secure device 10 decodes and parses the QR code to create a signature that includes the 2FA code, and an OP next step command. Then at step 164 secure device 10 sends the OP command to OP 2FA and the device ID to the API server 50. The SPK at this level may include a signature, time stamp, UDEK, and fingerprint data. Thereafter, API server 50 recognizes the 2FA from the secure device 10, sets the OP code as the 2FA OP code and routes control to the user account server 52 at step 166.

At Step 168, user account server 52 decrypts the data with SPK, verifies the time stamp, verifies the fingerprint data, and verifies the signature from the public key in the device database 54. Next, user account server 52 does the requested operation, for example change the password, change email, and/or reset password. If the requested operation is changing the web password then at step 168 user account server 52 re-encrypts the public keys with a new temporary password. Then, process flow continues to API server 50. At step 170 API server 50 returns the 2FA success to the secure device 10 and sets the OP code to 2FA success and then API server 50 sends process control to secure device 10 to display the command “You did 2FA correctly!”, for example.

Note that from step 162 also web server 56 may keep pinging user account server 52 to ask if the user account server 52 has been verified. This continues until a five minute timeout occurs, for example. Thereafter, web server 56 sends process control to API server 50 to perform step 174 to recognize the 2FA follow up and to determine the OP code value and then route control to the user account server 52. At step 178 in response to the user's account being verified user account server 52 begins the operation that the user requested. For example, change the password or whatever may be required.

Finally, user account server 52 sends control to API server 50 to route according to the requested operation.

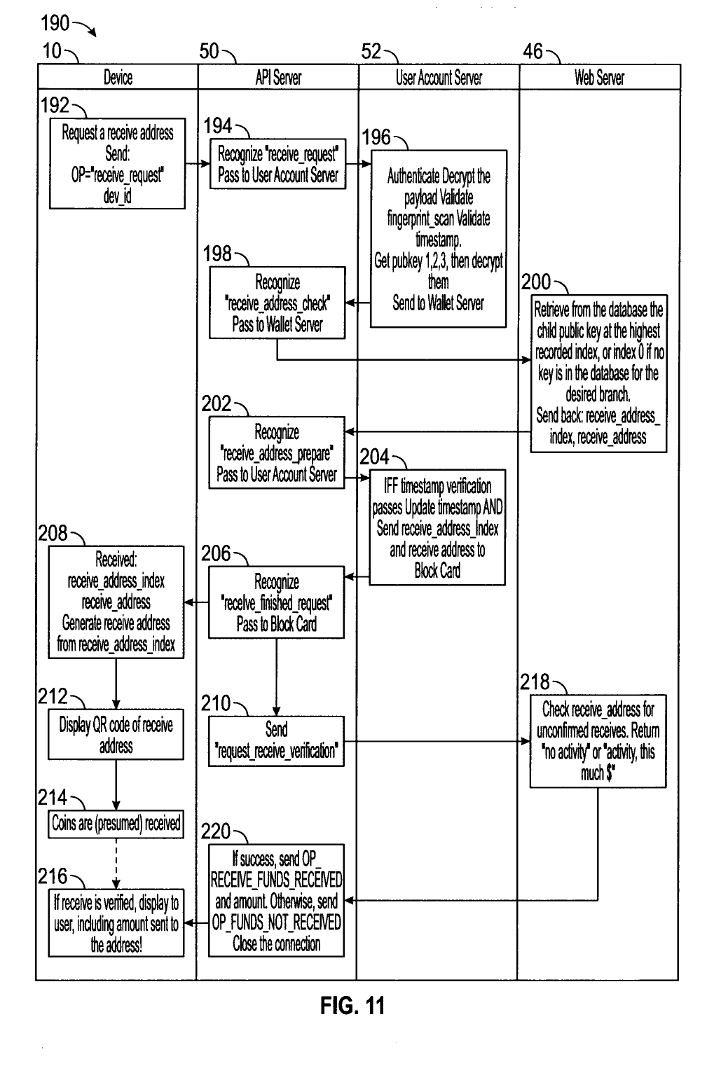

FIG. 11 shows an exemplary ‘received Bitcoin’ process flow 190 of the disclosed subject matter. As shown, an exemplary ‘received Bitcoin’ process flow 190 may begin at step 192 where secure device 10 requests a receive address and sends OP code value corresponding to the receive request to the PI server 50. This transmission from the secure device 10 may include UDEK, a fingerprint scan, and a time stamp and be encrypted with the shared private key. From step 192 process flow continues to API server 50 where at step 194 API server 50 recognizes the ‘receive_request’ and passes this request to user account server 52. At step 196, user account server 52 authenticates the MAC and decrypts the data with SPK. At step 196, user account server 52 may further validate the fingerprint scan, and validates the time stamp. User account server 52 may retrieve from the device database 54 the public keys 1, 2 and 3 and then decrypt the public keys using the UDEK. Continuing the process, user account server 52 may send public key 1, public key 2 and public key 3 as well as a device ID to wallet server 46. This may occur after process flow proceeds to step 198 API server where the API server 50 recognizes the ‘receive_address_check’ parameter and passes this information to wallet server 46. At step 200, wallet server 46 receives the row from lock table of the wallet database 48 that corresponds to the particular secure device 10. If the row is nonexistent, wallet server 46 will insert one into the lock table. Wallet server 46 also retrieves from the wallet database 48 in the child public key at least the highest recorded index. Alternatively, if the index is zero, if no key is in the wallet database 48 for the desired branch. Then, wallet server 46 will acquire the database lock. Further at step 200, if the current address has an empty transaction history wallet server 46 will send the current address. If the current address has a non empty transaction history, but all of the transactions are unconfirmed wallet server 46 will send the current address only if the current address was derived at index 0. Otherwise wallet server 46 will send the address at the previous index. If the current address has a non empty transaction history and at least one of those transactions has been confirmed wallet server 46 will update the wallet database 48 and recurse, checking the address at the next index. Step 200 further includes releasing the database lock and sending back the values received_address_index and receive address. Then process flows proceeds from wallet server 46 to API server 50 at which step 202 recognizes the “receive_address_prepare” from wallet server 46 and passes that information to user account server 52. Next, at step 204, user account server 52 applies the IFF time stamp verification passes an update the time stamp. Further at step 204, user account server 52 will send the receive_address_index parameter and receive_address parameter to secure device 10. Process flow proceeds further from step 204 to step 206 OP API server 50 where at step 204 API server 50 recognizes the “receive_finish_request” parameter and passes that information to secure device 10. At step 208 secure device 10 receives the ‘receive_address_index’ and the receive address from API server 50. Step 208 further involves generating a receive address from the receive_address_index and caching the new receive address index. From step 208, secure device 10 continues to step 212 to display the QR code of the receive address. At step 214, secure device 10 presumes that coins have been received.

As detailed, step 206 may further include API server 50 sending “request_receive_verification” command to wallet server 46, which at step 218 checks the receive address for unconfirmed receives. Wallet server 56 may return “no activity” or “activity this much $” at step 218. Continuing to step 220, API server 50 may send the parameter send the value OP_receive_funds received and the amount if successful if this is not successful then otherwise API server 50 will send OP_funds_not_received and close the connection. Thus, at step 216 block card 40 receives input at both step 214 where coins are presumed received or from step 220 if a receive is verified, information indicative of the verification and the amount will be displayed to the user, if unsuccessful, information indicative of the funds not being received will be displayed to the user.

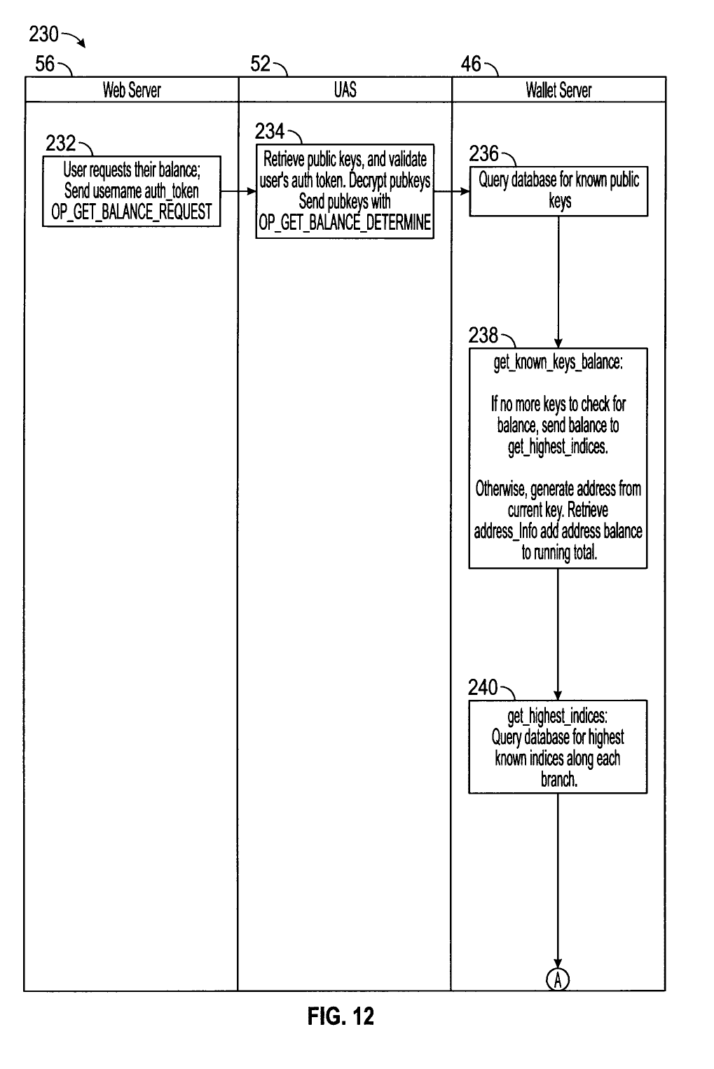

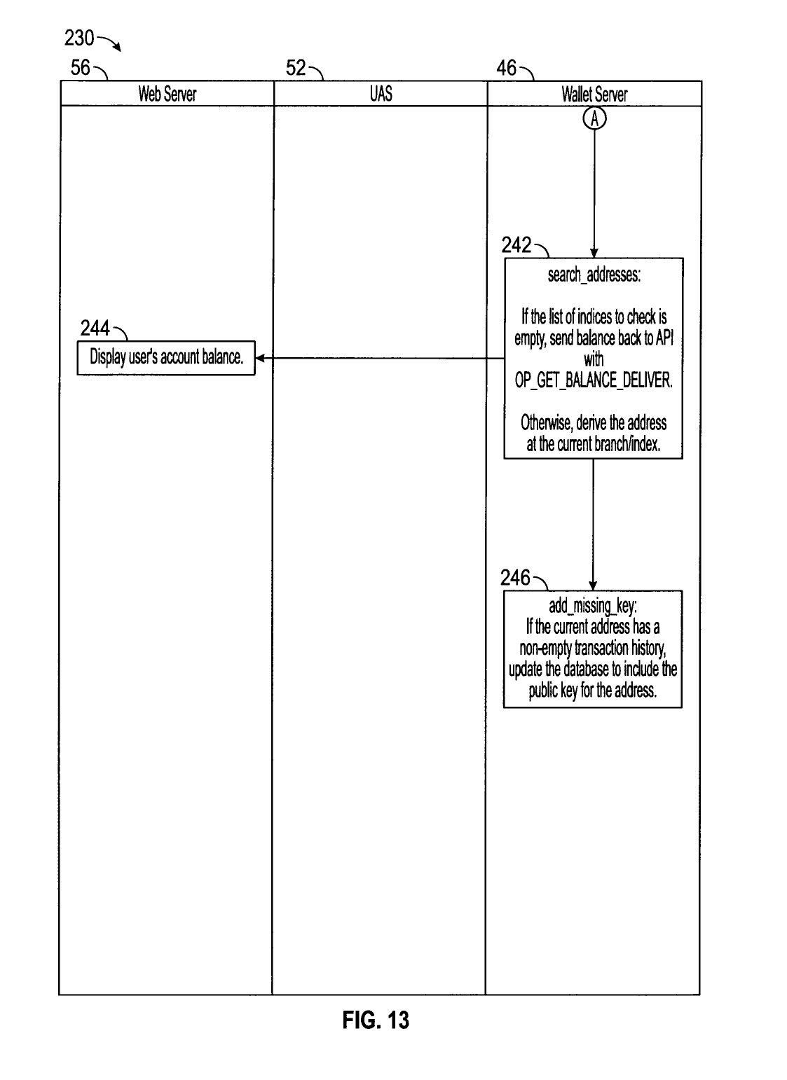

FIGS. 12 and 13 describe an exemplary ‘get Bitcoin balance’ process flow 230 of the present disclosure. As shown, a ‘get Bitcoin balance’ process flow 230 may begin at web server 56, when the secure device 10 requests a corresponding user balance. The web server 56 sends the username and data with the authorization token with the command op_{—} with the opcode op_get_balance_request at step 232. This transmission may be received by the user account server 52, where at a step 234 user account server 52 retrieves the public keys and validates the user authorization token. The user account server 52 decrypts the public keys with the user password.

Continuing the process flow, user account server 52 sends the public key with the opcode op_get_balance determine to wallet server 46. At step 236, wallet server 46 may query the wallet database 48 for known public keys. At Step 238, the wallet server 4 6 performs the balance getting function with the opcode get_known_keys_balance. If no more keys to check for balance exist, wallet server 46 will send the balance to get_highest_indices, which identifies a highest index in the list of indexes for the balance inquiry. Otherwise, wallet server 46 may generate an address from the current key. In this scenario, wallet server 46 may retrieve ‘addressed_info’ from insight and may then add the address's balance to the running total. This will asynchronously recurse with the updated balance and the list of keys to check.

Continuing the process to step 240, wallet server 46 may retrieve the highest indices. Retrieval of the highest indices may involve the querying of the wallet database 48 for the highest known indices along each branch. Wallet server 46 may add known indices one to each index and then may send the list of tuples containing (branch, index) to search addresses, along with the balance.

Continuing on to FIG. 13, a exemplary ‘get Bitcoin balance process flow’ 230 may include step 242 for search_address operation. In this step, if the list of indices to check is empty, wallet server 46 may send the balance back to the web server 56 with op_get_balance_deliver opcode. In an alternative scenario, wallet server 46 may derive the address at the current branch/index. This will query insight for information about the address. Step 242 may further include sending the address_info, indices_list, child_key, indices, and balance to add_missing_key.

Continuing the process flow, step 246 may include wallet server 46 performing the step add_missing_key. An ‘add_missing_key’ step may involve upon determination that a current address has a non-empty transaction history, wallet server 46 may update the wallet database 48 to include a public key for the address. Continuing the process, wallet server 46 may increment the index to check on the current branch. Furthermore, the step may include updating the running total of the balance and then sending the updated indices_list and balance to search addresses. In an alternative scenario, step 246 may include wallet server 46 removing the tuple corresponding to the current branch from the list of indices to check. Then step 246 completes with sending the updated indices list, and the tuple for the search addresses.

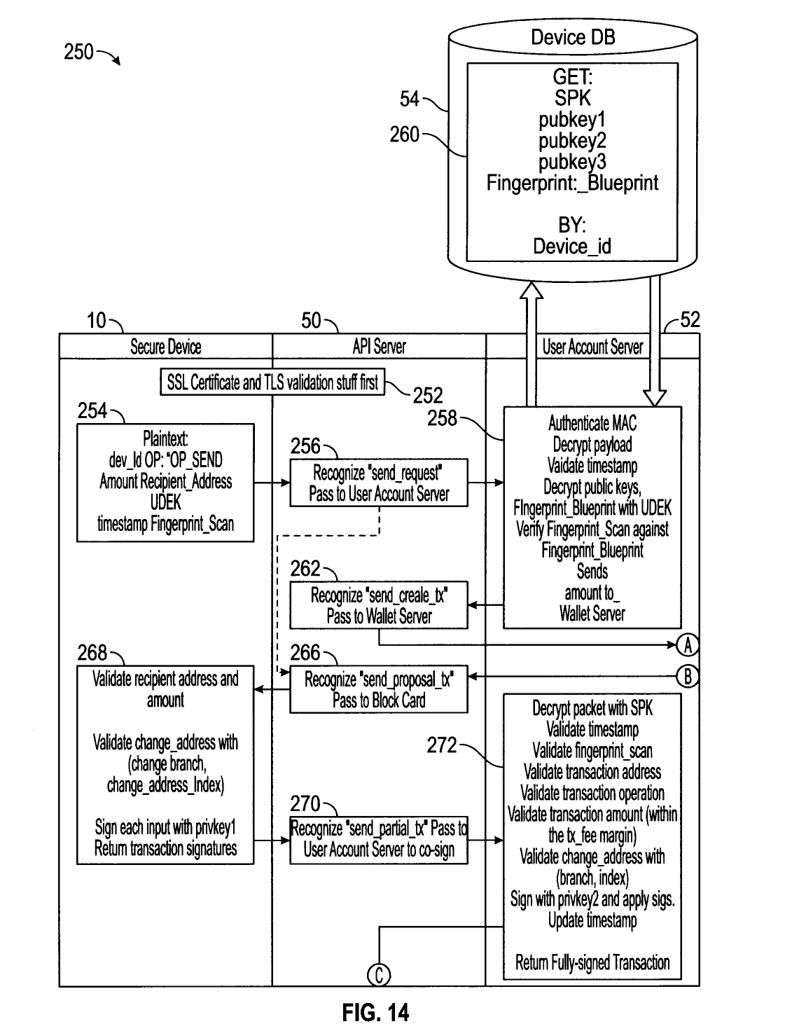

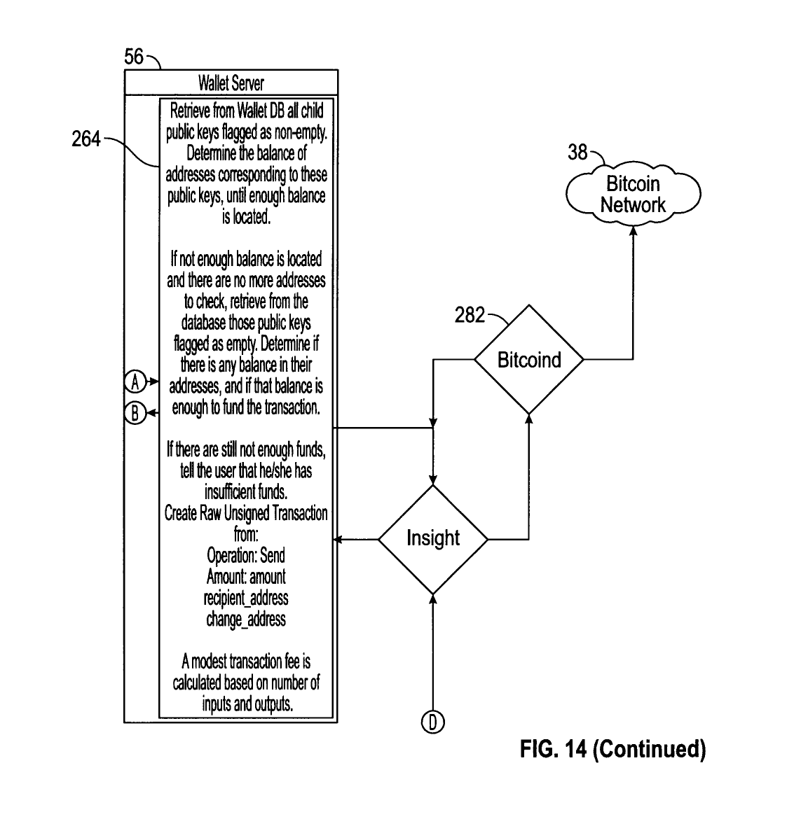

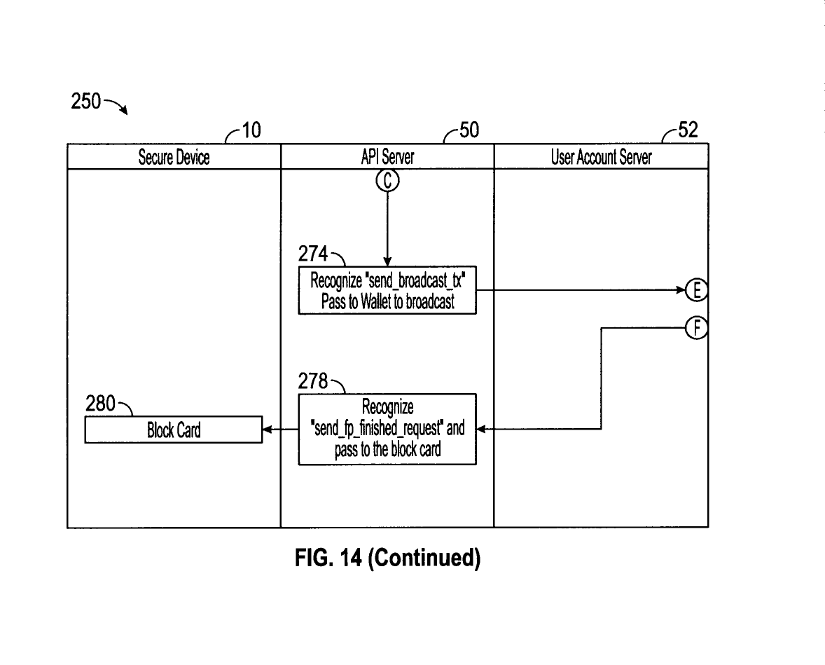

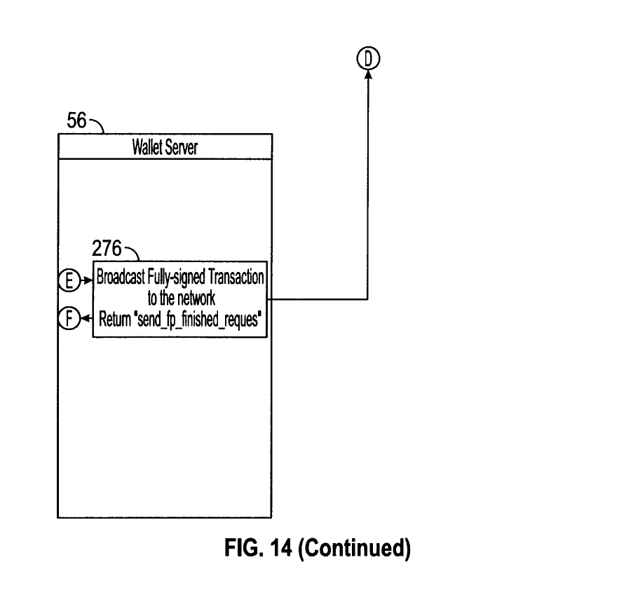

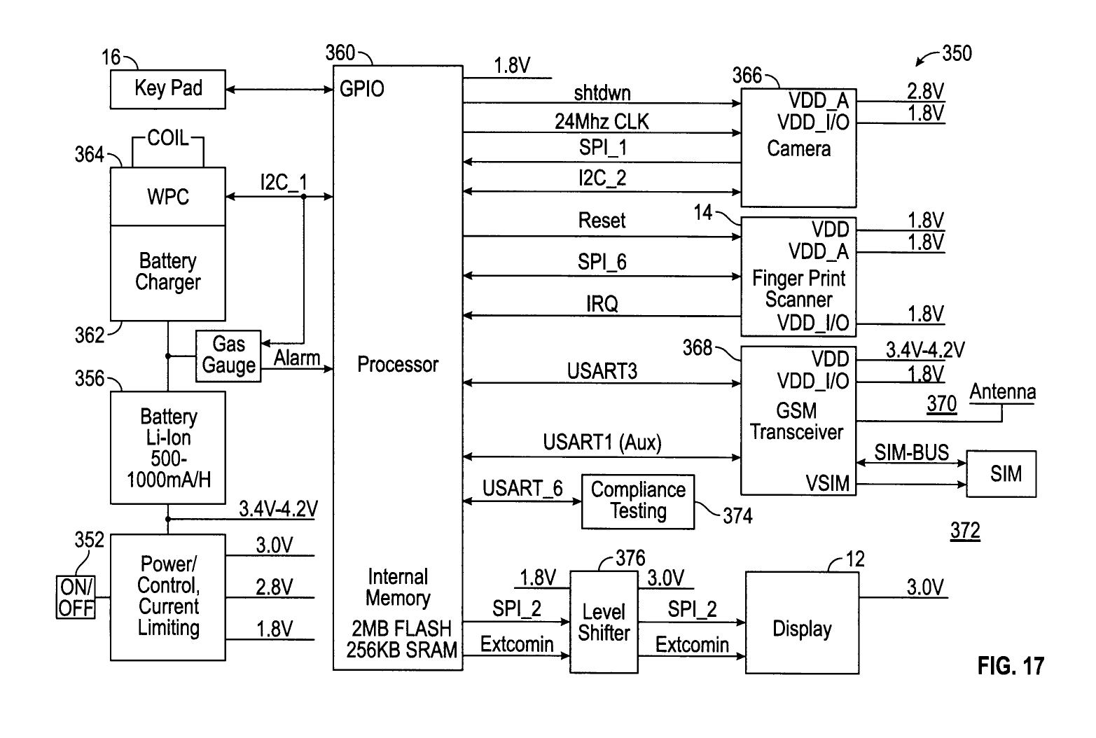

FIG. 14 illustrates an exemplary ‘send Bitcoin’ process flow 250 of the disclosed subject matter. As shown, a ‘send Bitcoin’ process flow may begin at secure device 10 and API server 50, step 252 depicts that SSL certificate and TLS validation would have occurred prior to the ‘send Bitcoin’ process flow 250 of FIG. 17. Assuming this has occurred, at step 254 secure device 10 sends a plain text device ID and an opcode “op_send”. This transmission may be encrypted with SPK, and the transmission may further include a currency amount, a recipient address, a UDEK, a time stamp, and a fingerprint scan. Continuing the process flow, API server 50 at step 256 may recognize a “send request” and pass this information, to user account server 52. At step 258, user account server 52 authenticates the MAC address and decrypts the data with the SPK. This authentication and decryption may be through communication with device database 54 wherein user account server 52 can retrieve the SPK public key 1, public key 2, public key 3 as well as a fingerprint blueprint according to the device identifier. As further shown, at step 258 user account server 52 may validate the time stamp, and may decrypt the public keys and fingerprint blueprint with the UDEK. User account server 52 may further verify the received fingerprint scan against the fingerprint blueprint or template, and upon successful verification, may transmit public key 1, pub key 2, pub key 3 the recipient address and the currency value to wallet server 46. Upon receipt, user account server 52 may cache the encrypted fingerprint scan on API server 50.

Continuing the Process flow, at step 262 API server 50 recognizes the “send_create_tx” parameter for the transaction and passes this information to wallet server 46. At step 264, wallet server 46 retrieves the row from the lot table corresponding to the secure device 10 if the row is nonexistent, then wallet server 46 will insert one into the table. Wallet server 46 may retrieve from wallet database 48 all child public keys flagged as nonempty. Then, wallet server 46 may determine the balance of addresses corresponding to these public keys until enough balance is located. If there is not enough balance located and there are no more addresses to check, wallet server 46 will retrieve from the wallet database 48 those public keys flagged as empty. Then, wallet server 46 will determine if there is any balance in their addresses and that if that balance is enough to fund that transaction. If the balance is still insufficient, wallet server 46 performs self-healing on the wallet database 48 and searches down each branch for any unrecorded child key with addresses with a nonempty transaction history and adds them to the wallet database 48. If any new addresses are located with a non-zero balance, wallet server 46 will determine if enough funds have been located yet.

If there are still not enough funds, wallet server 46 transmits to the secure device 10 an indication that insufficient funds are available. Alternatively if sufficient funds are available, wallet server 46 may determine the ‘change_address’ value from the latest empty entry in wallet database 48 and the public keys 1, 2, and 3. Upon completion, wallet server 46 may create a raw, unsigned transaction from the operation for sending to the secure device 10 via the API server 50 the currency value, the recipient address, and the change address. The transmission may further include the change branch, change_address index, for change address, and the branch, index tuples for the inputs. As shown at step 264, wallet server 46 may further calculate a transaction fee based on the number of inputs and outputs.

The process flow may continue to step 266 where API server 50, recognizes this send proposal transaction and passes that information to secure device 10. At step 268, secure device 10 may validate the recipient address and a currency value. Step 268 may further include secure device 10 validating the change address with the change branch, change address index tuple. At step 268, secure device 10 may sign each input with private key 1 and then return the transaction signatures instructing at least one of the user account server 52 and the wallet server 46 to sign the partially signed transaction and broadcast the multi-signed transaction to the cryptocurrency network 38 for completion. Process flow than continues to step 270 at API server 50. Note that at step 270 the stored SPK encrypted packet in the stored state is transferred from step 256 has previous been completed.

Continuing to step 270, API server recognizes the ‘send_partial_tx’ value and passes that to user account server 52 to cosign along with the SPK-encrypted packet. Process flow than continues to step 272.

At step 272, user account server 52 may decrypt the packet with SPK, may validate the time stamp, may validate the fingerprint scan, and may validate the transaction address and the transaction operation. User account server 52 may further validate the transaction amount within the transaction 3 margin, may validate the change address with the (branch, index) tuple, and may sign with the private key 2 and applies the signatures. As shown, Step 272 may further include user account server 52 updating the time stamp, and changing the address index of the device database. Upon completion, user account server 52 may return a fully signed transaction to API server 50. At step 274 API server 50 recognizes the “send broadcast transaction” and passes the broadcast transaction request to wallet server 46 for broadcast to the cryptocurrency network 38. From step 274 process control goes to wallet server 46 to broadcast the fully signed transaction to the cryptocurrency network 38 and then return the send fingerprint finish request at step 276 to API server 50. At step 278, API server 50 recognizes the ‘send_fp_finished_request’ value and passes that information to secure device 10. At step 280 secure device 10 indicates that the transaction is complete and the send has completed.

As shown in FIG. 13, between step 264 and 276, wallet server 56 may be in communication to the cryptocurrency network 38 for providing necessary inputs and decisions relating to bitcoinD step 282 and insight step 284, for example.

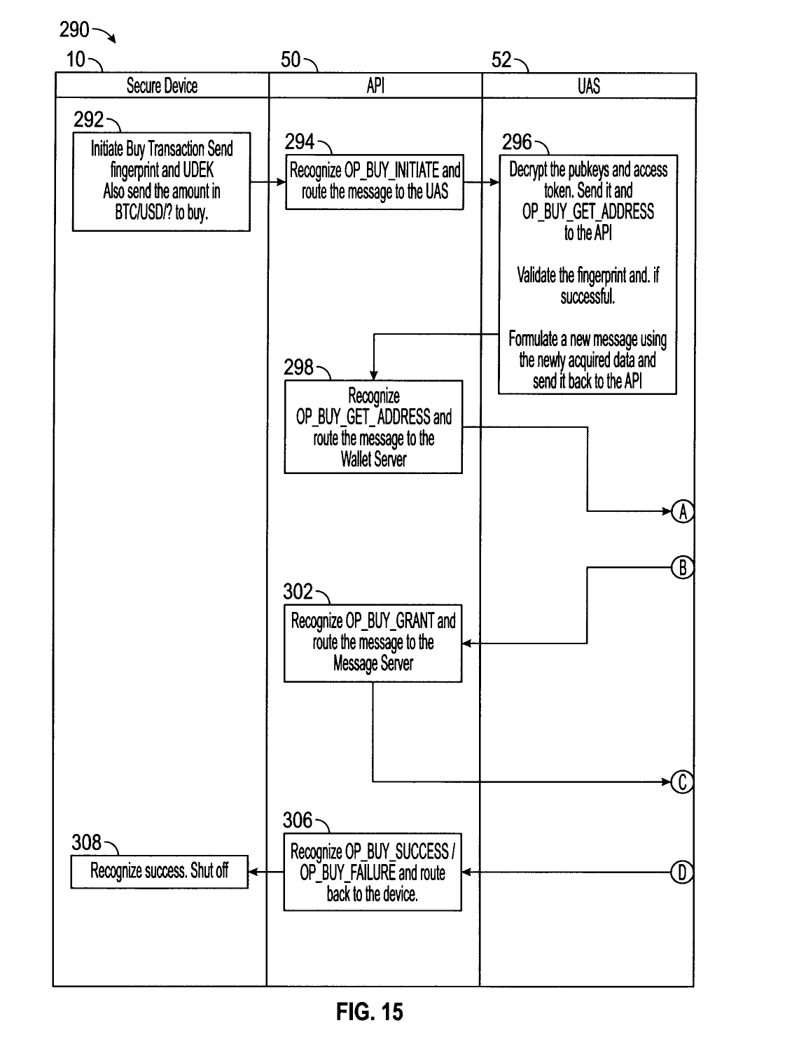

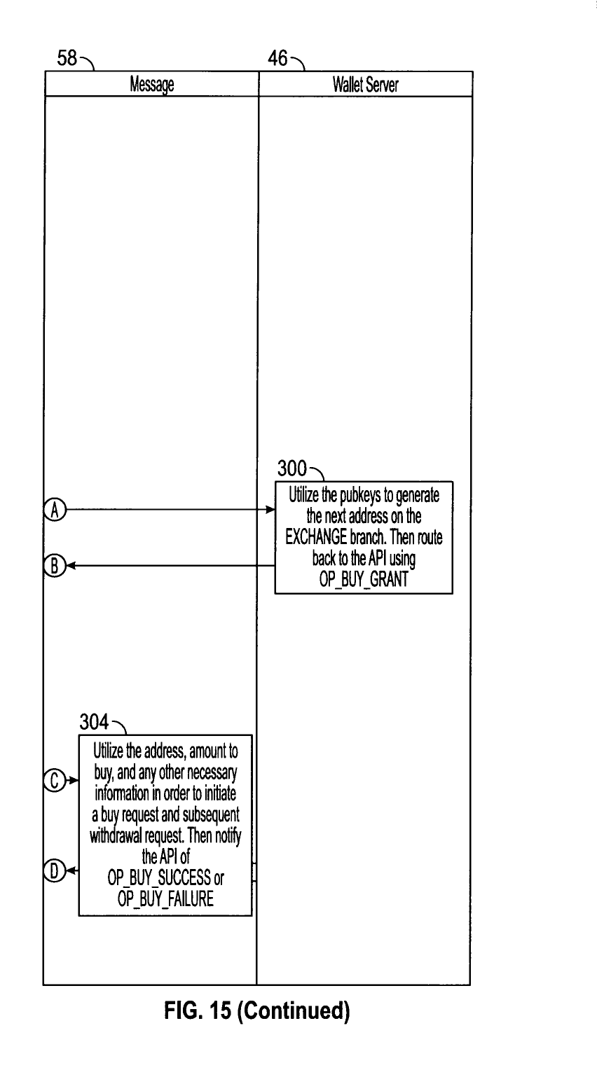

FIG. 15 shows an exemplary ‘buy Bitcoin’ process flow 290 of the present disclosure. As shown, a ‘buy Bitcoin’ process flow 290 may begin at step 292, wherein secure device 10 initiates a buy transaction. The secure device 10 may send a fingerprint and UDEK encrypted with the SBK. Upon receipt, user account server 52 may decrypt the access token. As shown, secure device 10 may also send a currency amount, e.g. Bitcoin, US dollars, or other currency, which is to be bought at step 292. Continuing to step 294, API server 50 recognizes the ‘op_buy_initiate’ opcode and routes that message to user account server 52. At step 296, user account server 52 decrypts the public keys and access token. Then, user account server 52 may send the decrypted information and the ‘op_buy_get_address’ to API server 50. Continuing step 296, user account server 52 validates the fingerprint and, if successfully validated, uses the UDEK to decrypt the public keys and access token. Continuing step 296, user account server 52 formulates a new message using the newly acquired data and sends this message to API server 50.

Continuing the process flow to step 298, API server 50 recognizes the ‘op_buy_get_address’ and routes the message to wallet server 46. At step 300, wallet server 46 utilizes the public keys to generate the next address on the exchange branch. Continuing step 300, wallet server 46 routes control back to API server 50 using the ‘op_buy_grant’ opcode.

Continuing the process flow to step 302, API server 50 recognizes the ‘op_buy_grant’ opcode and routes that message to message server 58.

Continuing the process flow to step 304, message server 58 may utilize the access token, the address, the amount to buy, and any other necessary information to initiate a buy request and a subsequent withdrawal request. Continuing step 304, message server 58 notifies API server 50 of an ‘op_buy_success’ opcode or an ‘op_buy_failure’ opcode.

Continuing to step 306, API server 50 recognizes the ‘op_buy_success’ or ‘op_buy_failure’ opcodes and routes the safe information back to secure device 10.

Continuing to step 306, secure device 10 may recognize the success in the ‘buy Bitcoin’ process flow 290 and turn off.

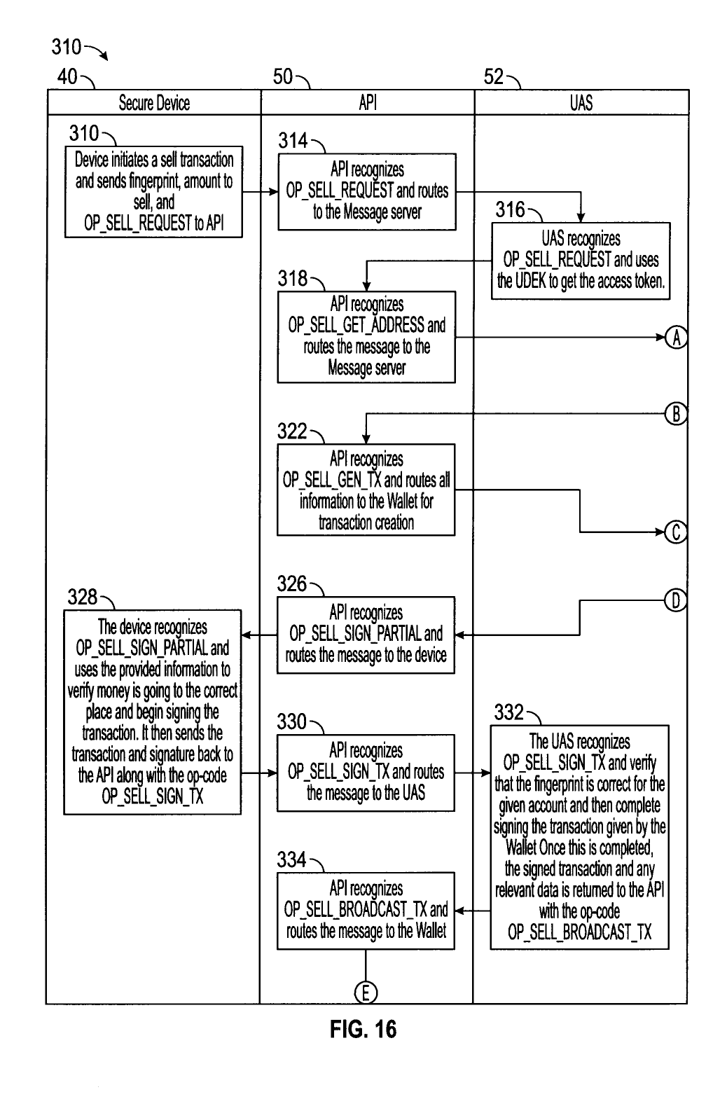

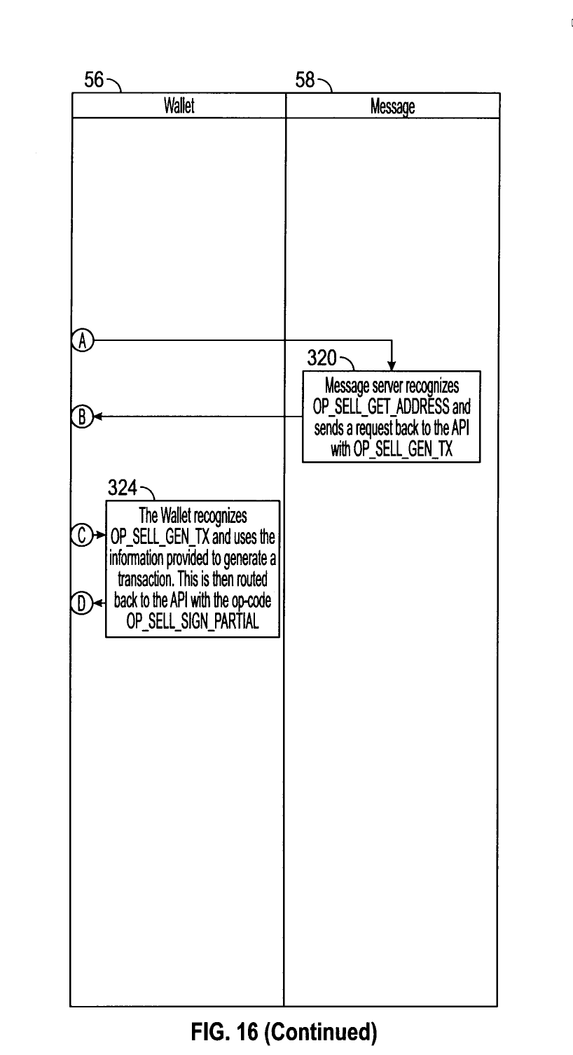

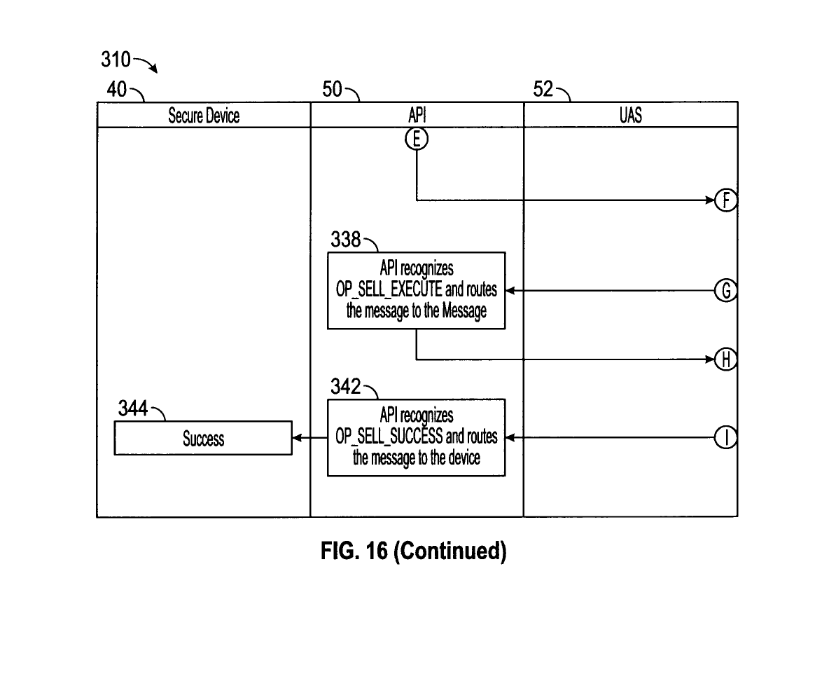

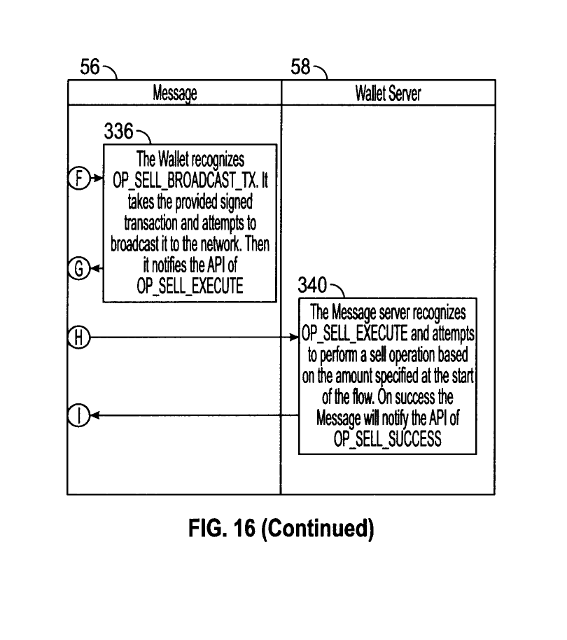

FIG. 16 shows an exemplary ‘sell Bitcoin’ process flow 310 of the present disclosure. As shown, a ‘sell Bitcoin’ process flow 310 may begin at step 312 where secure device 10 initiates a ‘sell transaction’ and sends fingerprint data, a currency value for sale, and a ‘op_sell_request’ op code to API server 50.

Continuing to step 314, API server 50 recognizes the ‘op_sell_request’ op code and routes this information to message server 58.

Continuing to step 316, user account server 52 receives and recognizes ‘op_sell_request’ op. User account server 52 may use UDEK to retrieve an access token. Upon successful retrieval of an access token, user account server 52 may send the access token back to API server 50 along with a ‘op_sell_get_address’ op code.

Continuing to step 318, API server 50 recognizes the ‘op_sell get’ address op code and routes the message to message server 58.

Continuing to step 320, message server 58 recognizes the ‘op_sell_get_address’ op code and sends a request to the salary/ME function. Upon success, the returned deposit address may be sent back to API server 50 along with the ‘op_sell_gin_tx’ op code for the transaction.

Continuing to step 322, API server 50 recognizes the ‘op_sell_gin_tx’ op code and routes information to the wallet server 46 for transaction creation.

Continuing to step 324, wallet server 46 recognizes the ‘op_sell_gin_tx’ op code and uses the information provided to generate a transaction. This is then routed back to API server 50 with the op code ‘op_sell_sign_partial’.

Continuing to step 326 API server 50 recognizes an ‘op_sell_sign_partial’ op code and routes the message to secure device 10.

Continuing to step 328 secure device 10 recognizes a ‘op_sell_sign_partial’ op code and uses the provided information to verify a currency value is going to the correct recipient. Upon successful verification of recipient, secure device 10 may begin signing the transaction with the private key stored on the secure device 10. Upon completion of the signing the transaction, secure device 10 may send the signed transaction to API server 50 along with the ‘op_sell_sign_tx’ op code instructing the API server to sell the cryptocurrency.

Continuing to step 330, API server 50 recognizes the ‘op sell sign tx’ op code and routes the message to user account server 52.

Continuing to step 332, user account server 52 recognizes the ‘op_sell_sign_tx’ op code and uses the UDEK/SPK to decrypt any necessary information from the received message such that it can verify that the fingerprint is correct for the given amount. Continuing Step 332, user account server 52 completes signing the transaction with the private key stored in the user database 54 for the secure device 10. Upon completion, the multi-signed transaction, and relevant data are sent from the user account server 52 to API server 50. This transmission may also include opcode ‘op_sell_broadcast_tx’. Continuing to Step 334, API server 50 recognizes the ‘op_sell_broadcast tx’ op code and routes the message to wallet server 46.

Continuing to step 336, wallet server 46 recognizes the ‘op_sell_broadcast_tx’ op code. Wallet server 56 utilizing the multi-signed transaction attempts to broadcast transaction to the cryptocurrency network 38. Continuing step 336, wallet server 46 notifies API server 50 of the ‘op_sell_execute’ op code.

Continuing to step 338, API server 50 may recognize the ‘op_sell_execute’ op code and routes the message to message server 58.

Continuing to step 340, message server 58 may recognize the ‘op_sell_execute’ op code and may perform a sell operation for the currency value. Upon confirmation of successful sell operation, message server 58 may notify API server 50 of the ‘op_sell_success’ op code.

Continuing to step 342, API server 50 recognizes the ‘op_sell_success’ op code and routes the message to secure device 10.

Continuing to step 344, secure device 10 upon receipt of message from API server 50 indicates success of the ‘sell Bitcoin’ process flow.

FIG. 17 shows an exemplary secure device 10 functional block diagram 350 and it should be understood that the secure device 10 is not limited to the components and/or arrangements set forth in FIG. 17. As shown, the functional block diagram 350 provides a simplified view of the circuitry for performing the functions of secure device 10. The secure device 10 may include an on/off switch 352, a power control/current limiting circuit 354, a power source 356, and a microprocessor 360. When the on-off switch 352 is turned on, power is either provided to and/or a control signal is provided to activate the power/control limiting circuit 354. Power/control current limiting circuitry 354 receives a 3.4 to 4.2 V signal from the battery 356 and generates a three-volt, a 2.8-volt, and a 1.8-voltage output.

Circuitry connects battery 356 to battery charger 362 and WPC circuit 364. This input goes to gas gauge 358 to determine how much charge is remaining in the battery 356 to indicate whether an alarm condition should be triggered to processor 360.

Processor 360 provides two megabytes of flash memory as well as 256 kilobytes of ESRAM. Processor 360 communicates with WPC circuitry 364 as well as keypad 16 for general purpose 10 communication. Processor 360 communicates i2c_{—}2 data with camera 366, receives SPI_1 input from camera 366 and communicates shutdown and a 24-megahertz clock signal to camera 366.

Voltage for camera 366 includes a 2.8V address voltage and a 1.8 volt IO voltage. Processor 360 also communicates SPI_6 data to fingerprint scanner 14. Fingerprint scanner 14 may receive a reset signal from processor 360 as well as provide an IRQ signal back to processor 360.

Processor 360 also communicates USART3 and USART1 (Auxiliary) data with GSM receiver 368. Fingerprint scanner 14 receives voltage input including VDD 1.8 and VDD address 1.8 and VDD_IO voltages, all 1.8 volts.

GSM receiver 368 receives a VDD 3.4 to 4.2 volts and a VDDI/O voltage input of 1.8 volts. GSM receiver 368 further communicates with GSM antenna 370. Also, connecting and communicating with GSM receiver 368 is SIM circuit 372 for receiving and responding to a SIM data and circuitry. Processor 360 communicates USART communications with compliance testing circuitry 374. Also, processor 360 provides SPI 2 communication and external communication instructions to level shifter 376. Level shifter circuit 376 shifts level from 1.8 volts to 3.8 volts to provide voltage and communications SPI2 and Extcomin signals to display 12 of secure device 10. Display 12 also receives a 3.0 volt input.

Should a user lose or damage its secure device 10, or for any other reason, determine that a recovery procedure needs to take place, the user would be directed to initiate contact with a secure device company who had access to the device database 54 and would be responsible for verifying the identity of the user and the user's authority to initiate the request. The recovery private key stored in the vault may be under the control of a recovery key company that may be separate from the secure device company. In the event of a lost or damaged user device 10, this verification process could include sending a new user device 10 so that the user can provide a fingerprint scan for verification. Once verification has been achieved, the user may then provide a cryptocurrency address that will receive the recovery funds.

Once all of the information necessary to complete the request for signature using the recovery key has been collected by the secure device company from the vault company, a request to transfer cryptocurrency from a cryptocurrency address associated with the lost or stolen user device 10 to a new cryptocurrency address associated with the new user device 10 is initiated. Included in the request would be authorization from the user making the request, the reason for the request, the amount of cryptocurrency being transferred, and the receive address (e.g., both a plain text name provided by the user and the bitcoin sweep address) that will receive the cryptocurrency from the recovery operation. Once completed and formatted, the request for signature using the recovery key is sent to the recovery key company.

When a request for signature using the recovery key is received, the recovery key company may then send out a notice to at least two contacts at the secure device company that had been previously registered. The notice can be sent by email telephone call or any other methodology for verifying the notice. The request for signature may not move forward unless a positive response has been received from a predefined number of independent contacts at the secure device company. This procedure is present to help guard against a rogue employee improperly initiating a request.

Once verification is received from the secure device company, the recovery key company would then send out a formatted notice, included as part of the request received from the secure device company, to an email address or other previously registered contact methodology of the user. This notice will be clearly identified as originating with the secure device company, but sent by the recovery key company. This keeps the transaction as being with a company the user knows and trusts but also makes clear that the secure device company is using a third party verification, much like an audit, to further protect the user's recovery key. If the user replies that the request is a valid request, then the recovery key outsource company would sign the attached cryptocurrency send request and return the partially signed send request back to the secure device company for final signature and broadcasting of the transaction to the cryptocurrency network.

If the user replies that the request appears to be in error, the request is immediately denied. The formatted notice may include contact information for appropriate representative(s) of the secure device company to whom the user could discuss the formatted notice should they perceive the formatted notice to be in error. This error, in addition to being the user did not initiate the recovery process, could be that the receive address is wrong, that the amount of cryptocurrency is wrong, or any other such detail.

If the user fails to reply for a predetermined time, such as three days, the secure device company may be notified and the formatted notice may be resent to the user contact information. If the user fails to reply for an additional predetermined time, e.g., three days, the secure device company is again notified and the request may be resent one last time. If the user fails to reply, the recovery request is denied, the transaction to transfer funds to the new address is not signed, and the secure device company is notified that the user failed to authorize the transaction.

In one embodiment, the user is not required to provide any information other than a simple “Yes” or “No” answer to the formatted notice that the requested transaction is valid or invalid, respectively. When the user first signs up for the user device service, it will be made very clear that the user will not receive a request for more information—that in the event of a recovery, the user will be receiving a notification from the recovery key company. This should prevent fishing attempts to obtain additional information from the user.

Additional safeguards may also be in place. For example, personnel of the user device company may be responsible for registering the list of user device company contacts but would not be a contact herself Furthermore, when a change in the list of contacts occurs, a notice may be sent to all of the previous contacts so they would be aware the change is being made. However, this change does not require any response from those previous contacts to occur. This notification is purely informational in the event secure device company personnel have gone rogue. This provides other personnel of the secure device company the chance to notify the recovery key company that something strange is going on and they can use their discretion as to whether to deny any requests temporarily until the situation has been resolved to their satisfaction.

Furthermore, for those individuals who wish to go one step further in ensuring that they, and only they, are able to release the cold storage key, the user device company may allow the user the ability to provide their own cold storage of the recovery key. While this solution won't work for most users, whether due to a lack of knowledge about recovery key generation and storage or due to a lack of interest in expending the effort necessary to provide a reliable means to store and recover the recovery key, for those who have both the knowledge and interest, this option is available to them.

Although the presently disclosed inventive concepts have been explained in relation to its preferred embodiment, it is to be understood that many other possible modifications and variations can be made without departing from the spirit and scope of the invention as herein described

1. A secure device, comprising:
a wireless transceiver;
a microprocessor coupled to the wireless transceiver;
a digital storage element coupled to the microprocessor and storing logic that when executed by the microprocessor causes the microprocessor to:
generate and encrypt a request to transfer a requested amount of cryptocurrency from a user address to a destination address, the request including the destination address, the requested amount, and multi-factor user identification information;
enable the wireless transceiver to transmit the request to one or more server;
enable the wireless transceiver to receive an unsigned transaction to transfer the requested amount of cryptocurrency, the unsigned transaction including a destination address, and a requested amount, the transaction being generated by the one or more server;
verify the authenticity of the transaction including the destination address and the requested amount and upon verification generate a partially signed transaction by cryptographically signing the unsigned transaction; and
enable the wireless transceiver to transmit the partially signed transaction to the one or more server instructing the one or more server to sign the partially signed transaction and broadcast a multi-signed transaction to a cryptocurrency network.

2. The secure device of claim 1, further comprising a display screen and input device coupled to the microprocessor, and wherein the logic, when executed by the microprocessor, causes the microprocessor to verify the authenticity of the unsigned transaction including the unsigned destination address and the unsigned requested amount by displaying the unsigned destination address and the unsigned requested amount on the display, and receiving a signal from the input device indicative of the verification of the authenticity of the unsigned transaction.

3. The secure device of claim 1, wherein the unsigned transaction data further comprises a change address, and wherein the logic, when executed by the microprocessor, causes the microprocessor to verify the authenticity of the unsigned transaction including the unsigned destination address, the unsigned requested amount and the change address.

4. The secure device of claim 1, further comprising a cryptography chip coupled to the microprocessor, and wherein the logic, when executed by the microprocessor, causes the microprocessor to generate a partially signed transaction by enabling the cryptography chip to cryptographically sign the unsigned transaction.

5. The secure device of claim 4, wherein the microprocessor includes an embedded cryptography chip component.

6. The secure device of claim 1, wherein the wireless transceiver conforms to the requirements of a global system for mobile communications protocol.

7. The secure device of claim 1, wherein the one or more server are outside of a bitcoin network.

8. The secure device of claim 1, wherein the cryptographically signing is accomplished with a private key of a multi-private key cryptography scheme.

9. A secure device, comprising:
a wireless transceiver;
a camera;
a fingerprint scanner;
a microprocessor coupled to the wireless transceiver, the camera and the fingerprint scanner;
a digital storage element coupled to the microprocessor and storing logic that when executed by the microprocessor causes the microprocessor to:
activate the camera to capture a visual data including raster content at least identifying a destination address;
activate the fingerprint scanner to scan a user's finger and generate digital data indicative of minutia of the user's finger;
generate and encrypt a request to transfer a requested amount of cryptocurrency from a user address to a destination address, the request including the destination address, the requested amount, a user device encryption key, and the data indicative of minutia of the user's finger; and
enable the wireless transceiver to transmit the request to one or more server.

10. The secure device of claim 9, wherein the visual data includes a quick response code, and wherein the logic, when executed by the microprocessor causes the microprocessor to locate and decode the quick response code to derive the destination address.

11. The secure device of claim 9, wherein the visual data includes a pattern and wherein the logic, when executed by the microprocessor causes the microprocessor to locate and decode the pattern to derive the destination address.

12-18. (canceled)

19. A method, comprising:
generating and encrypting a request on a secure device to transfer a requested amount of cryptocurrency from a source address to a destination address, the request including the destination address, the requested amount, and multi-factor user identification information;
transmitting the request from the secure device to one or more server, instructing the one or more server, upon successful verification, to generate a transaction for the transfer of cryptocurrency;
receiving on the secure device an unsigned transaction to transfer the requested amount of cryptocurrency from the one or more server;
verifying, by the secure device, the authenticity of the unsigned transaction including the multi-factor user authentication data, the source and destination address, and the amount to transfer, and upon verification, cryptographically signing the unsigned transaction to create a partially signed transaction; and
transmitting the partially signed transaction to the one or more server instructing the one or more server, upon successful verification, to sign the partially signed transaction and broadcast a multi-signed transaction to a cryptocurrency network.

20. The method of claim 19, wherein verifying the authenticity of the unsigned transaction including the unsigned destination address and the unsigned requested amount includes displaying the unsigned destination address and the unsigned requested amount on a display, and receiving a signal from an input device indicative of the verification of the authenticity of the unsigned transaction.

21. The method of claim 19, wherein the unsigned transaction data further comprises a change address, and wherein verifying the authenticity of the unsigned transaction includes verifying the unsigned destination address, the unsigned requested amount and the change address.

22. The method of claim 19, wherein the cryptocurrency conforms to the requirements of Bitcoin, and the one or more server are outside of a bitcoin network.

23. The method of claim 19, wherein the multi-factor user authentication data includes at least one of a fingerprint scan of the user, a password entered by the user, or a unique device identifier from the user's secure device.

24. A method, comprising:
generating and encrypting a transaction on a secure device to transfer a requested amount of cryptocurrency from a source address to a destination address, the transaction including the source address, destination address, the requested amount, and multi-factor user identification information; and
cryptographically signing the transaction and transmitting the partially signed transaction to one or more server, instructing the one or more server, upon successful verification, to sign the transaction for the transfer of cryptocurrency and to broadcast a multi-signed transaction to a cryptocurrency network.

25. A method, comprising:
receiving a request, on one or more server, from a secure device requesting the creation of a transaction for the transfer of cryptocurrency, said request including a destination address, the transfer amount, and multi-factor user identification information;
verifying on the one or more server, the validity of the transfer, including authenticating the multi-factor user identification information, the source address, the destination address, and the transfer amount, and upon successful verification, generating an unsigned transaction for the transfer of cryptocurrency;
transmitting the unsigned transaction to the secure device for authentication and partial signing;
receiving, on one or more server, a partially signed transaction from the secure device;
verifying on the one or more server, the partially signed transaction, including authenticating the multi-factor user identification information, and upon successful verification, cryptographically signing the transaction to create a fully signed transaction; and
transmitting the fully signed transaction for broadcast to a cryptocurrency network.

26. A method, comprising:
receiving a partially signed transaction, from a secure device, to transfer a requested amount of cryptocurrency from a source address to a destination address, the transaction including the source address, destination address, the requested amount, and multi-factor user identification information; and
verifying the partially signed transaction, including verifying the multi-factor user identification information, and upon successful verification, cryptographically signing the transaction and transmitting the fully signed transaction for broadcast to a cryptocurrency network.
